(19) United States
(12) Patent Application Publication
(10) Pub. No.: US 2019/0156699 A1
(43) Pub. Date: May 23, 2019

(54) Dynamic And Adaptive Conditioning For Nutritional Substances

(71) Applicant: Iceberg Luxembourg S.A.R.L., Luxembourg (LU)

(72) Inventor: Eugenio Minvielle, Hillsborough, CA (US)

(21) Appl. No.: 16/195,523

(22) Filed: Nov. 19, 2018

Related U.S. Application Data
(60) Provisional application No. 62/588,220, filed on Nov. 17, 2017.

(51) Int. Cl. G09B 19/00; G06F 16/2457; G09B 5/00

(52) U.S. Cl. CPC G09B 19/0092; G09B 5/00; G06F 16/2457

(57) ABSTRACT

The present disclosures relate to systems and methods for dynamic and adaptive conditioning of nutritional substances. In some embodiments, the present disclosures further relate to dynamic recipes and food building blocks (FBB) which are a combination of variables used to build instructions and processing of nutritional substances in conditioning systems uniquely based on consumer preferences.

### CROSS REFERENCE TO RELATED APPLICATIONS

This application claims priority to U.S. Provisional Application No. 62/588,220, titled “DYNAMIC AND ADAPTIVE CONDITIONING OF NUTRITIONAL SUBSTANCES,” filed Nov. 17, 2017, the contents of which are incorporated herein by reference.

### FIELD

The present disclosure relates to systems and methods for dynamic and adaptive conditioning of nutritional substances.

### BACKGROUND

The following description includes information that may be useful in understanding the present disclosure. It is not an admission that any of the information provided herein is prior art or relevant to the presently claimed invention, or that any publication specifically or implicitly referenced is prior art.

There are a significant number of conventional conditioning programs available in printed and digital media for food preparers and consumers. In digital form, conditioning programs can be shared through social media. These conditioning programs are rigid; they provide a static list of nutritional substances (e.g. food items or ingredients), methods, accessories, and a single of specific instructions for preparing a particular meal or dish. These traditional conditioning programs rarely propose alternatives. For example, a meal preparer is left without alternate ingredient options when a preferred accessory or ingredient is unavailable to him/her.

Conventional meal preparation instructions also have no flexibility for alternate options in the preparation steps. Conditioning instructions can prescribe the preparation of the ingredients (slicing, mushing, peeling, among other actions) and conditioning parameters (such as time, temperature and a conditioning mode). If a specific conditioning mode is not available in the conditioner, the food preparer is left guessing as to what other mode available on the conditioner can be used in lieu of the prescribed mode. Conventional conditioning modes often include bake, roast, and grill, while some high-end conditioners feature special conditioning modes that are unavailable in other conditioners (e.g. steam or convection microwave plus broil). These special conditioning modes cannot be used with lower-end conditioning programs, as the parameters for these special modes are not prescribed.

Moreover, traditional conditioning programs do not allow the consumers to personalize meals based on their preferences food allergies or intolerances. They do not take into account the state of the food nor give instructions as to how best leverage the ingredients the meal preparer has on hand. The nutritional value and food allergen information of these static conditioning programs is fixed, that is, if the publisher of the conditioning program recommends a replacement of an ingredient and the food preparers replace the ingredient, the new nutritional value or potential food allergens are not communicated. This new information can have implications on the health of the actual consumer of the meal.

Shahar (U.S. Pat. No. 9,754,508) describes a method and system for analyzing and processing an analog or digital food recipe and transforming it into machine-readable recipes. This machine-readable recipe allows the user to scale the recipe and provides a nutritional information and a dietary analysis. However, the user must provide the ingredient substitutions and manually enter the substitutions into Shahar's Recipe Analyzer Program, along with modified instructions. Shahar does not provide for media content such as videos or voice commands.

In addition, creating digital content (video, audio or text) for every conditioning protocol is time consuming and expensive. For instance, in order to generate one hundred digital conditioning protocols, conventional conditioning methods require the production of one hundred sets of unique videos, ingredient list and instructions. In addition, if appliance manufacturers or FMCG would like to have one or several of these conditioning protocols tailored made for their brand, it will be required to generate a new set of conditioning protocols and digital media due to their static and inflexible design.

Furthermore, the inflexibility of the traditional conditioning protocols does not allow a variable calculation of a meal preparation time depending of the skill of the food preparer. Rather, conventional time estimates are high-level estimates as based on assumptions about an average food preparer made by the conditioning program.

Therefore, when food preparers who lack culinary experience are generally unknowledgeable about viable substitutions and variations in preparation and conditioning methods for any given meal; these food preparers are forced to provide the ingredients and accessories dictated by the recipe and follow the preparation methods dictated by the conditioning program. Altogether, traditional conditioning programs, in general, do not consider (1) a consumer's allergies and health conditions, (2) preferential ingredient substitutions, (3) differences among various brands and models of conditioners, or (4) conditioning skills of a meal preparer.

These flaws in conventional conditioning programs result in fewer consumers preparing or eating meals at home; this can have the effect of less time with family at the table. As an analogy with automobile guidance systems, this type of conditioning programs takes the user to a destination using one inflexible route (just like a paper map), rather than describing a journey. Accordingly, a significant new way of addressing these limitations is needed.

### SUMMARY

The present disclosure provides for systems and methods for creating an interactive and executable cooking program. In a first embodiment of the present disclosure, a method can provide for first receiving, at a user interface, a selection of a meal. The method can then provide for identifying, by a control system, a set of components associated with the meal. The method can then provide for loading, from a database, cook sequences associated with each of the set of components. A first cook sequence associated with a first component of the set of components can include a first set of instructions. The instructions can be executable by a conditioner. The method can then provide for generating, by the control system, a generic cook program based on the cook sequences. The generic cook program can include a cook timeline. The cook timeline can have each of the cook sequences arranged with respect to each other so that each cook sequence is initiated at a certain point along the cook timeline. The method can then provide for executing, by the control system, the generic cook program on a smart device. The smart device can have a display. The control system can initiate each of the set of cook sequences as the generic cook program advances along the cook timeline. The first set of instructions executable by a conditioner can be executed after the first of the loaded cook sequences is initiated.

In some examples of the first embodiment, the first cook sequence can be associated with a first content. The first content can be displayed on the display after the first cook sequence is initiated.

In some examples of the first embodiment, identifying a set of components associated with the meal can include a series of steps. First, the steps can provide for identifying a set of standard components associated with the meal. Second, the steps can provide for determining, based on a profile of the user stored in a second database, that at least one of the components should be substituted. Then, the steps can provide for identifying, in a database, a substitute component associated with the meal and associated with at least one of the components that should be substituted. Lastly, the steps can provide for outputting the set of components with the substitute component replacing the at least one of the components that should be substituted.

In some examples, the profile of the user can include allergy information, nutritional preferences, and/or cooking preferences.

In some examples of the first embodiment, arranging each of the cook sequences with respect to each other so that they are initiated at a certain point along the cook timeline further comprises determining a length of time in each of the cook sequences and arranging each of the cook sequences along the cook timeline so that the cook sequences all finish within a certain window of each other.

In some examples of the first embodiment, a length of the cook timeline is dependent on an expertise level associated with the user profile.

In some examples of the first embodiment, the first content comprises at least one of text, a video, or an image.

The present disclosure can also provide for systems and methods for creating a conditioning protocol for a conditioner. In a second embodiment of the present disclosure, a method can include receiving, at a user interface, user input from a user. The method can then provide for determining, at a remote database, whether the user has an existing profile. The method can then add the received user input to the existing profile if the remote database determines that the user has an existing profile. The method can construct a profile for the user, to yield an existing profile, if the remote database determines that the user does not have an existing profile. The method can then provide for building a conditioning protocol. The conditioning protocol can be based on the existing profile, the user input, and a stored set of exemplary protocols. The method can then provide for executing the built conditioning protocol in a conditioner.

In some examples of the second embodiment, the user interface, the remote database, and the conditioner can be a single component. In other examples, one or more of the three can be separate components.

In some examples of the second embodiment, the method can further provide for displaying the built conditioning protocol at the user interface.

In some examples of the present disclosure, executing the built conditioning protocol in a conditioner can comprise automatically initiating a cooking process on the conditioner.

In some examples of the second embodiment, the user input can include any of: at least one dietary preference, at least one dietary requirement, sensor data, at least one available ingredient, at least one available appliance, a number of food preparers, and a meal selection.

In some examples of the second embodiment, the sensor data can include a readiness of an ingredient.

In some examples of the second embodiment, the sensor data can be collected by at least one sensor configured to receive data from the at least one ingredient. In some examples, the sensor can include at least one of a heat sensor, a camera, and a near infrared spectroscopy sensor.

In some examples of the second embodiment, the conditioning protocol can include (1) selecting a protocol of the stored set of exemplary protocols and (2) automatically adjusting at least one element of said protocol based on at least one of the user input and the existing profile.

In some examples of the second embodiment, the at least one element can include at least one of: an ingredient, an order of protocol elements, a length of time of a protocol element, a length of time of the built conditioning protocol, a technique step, and an appliance step.

In some examples of the second embodiment, the adjusting can include replacing, removing, or adding a new element to said protocol.

In some examples of the second embodiment, the built conditioning protocol can include at least one of: an ingredient building block, a content building block, a dynamic food bolt, a component, and an appliance building block.

In some examples of the second embodiment, the built conditioning protocol can include at least one of verbal user instructions, textual user instructions, and digital media instructions.

A third embodiment of the present disclosure can provide a system for creating a conditioning protocol. The system can include a user interface, a remote database, and a computing device. The user interface can be configured to receive user input from a user. The remote database can be configured to perform a series of steps. For example, the remote database can receive, from the user interface, a selection of a user. The remote database can determine whether the selected user has an existing profile. Based on determining that the user has an existing profile, the remote database can provide for adding the received user input to the existing profile. Based on determining that the user does not have an existing profile, the remote database can provide for constructing a profile for the user, to yield an existing profile. The computing device can be configured to build a conditioning protocol. The conditioning protocol can be based on the existing profile, the user input, and a stored set of exemplary protocols. The computing device can further provide for executing the built conditioning protocol in a conditioner.

Various aspects of the third embodiment can be as discussed with respect to examples of the second embodiment.

A fourth embodiment of the present disclosure can provide for a non-transitory computer-readable medium. The non-transitory computer-readable medium can have a stored computer program. The computer program can be executable by a computing device. The computer program can include code sections. The code sections can cause the computing device to perform a series of steps. The steps can include performing the method of the first disclosure.

Various aspects of the fourth embodiment can be as discussed with respect to examples of the second embodiment.

With regards to the present disclosure, a “conditioner” can be any electrical or mechanical machine which has cooking or food preparation functionality.

With regards to the present disclosure, a “conditioning protocol” can be a program, application, digital or print listing, which provides a series of instructions for preparing a food item. In some examples, the conditioning protocol can be provided for user consumption and/or for execution by a conditioner.

### BRIEF DESCRIPTION OF THE FIGURES

The accompanying drawings, which are incorporated in and constitute a part of this specification, exemplify the embodiments of the present disclosure and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIGS. 1A-1B show an exemplary schematic of how food building blocks (FBB) can be integrated to form Dynamic Food Bolts (DFB), according to an embodiment of the present disclosure;

FIGS. 2A-2B show an exemplary schematic of how the Dynamic Food Bolts (DFBs) can be combined with ingredient building blocks (IBB), Technique Building Blocks (TBB), and Content Building Blocks (CBB) to yield a Component, according to an embodiment of the present disclosure.

FIG. 3 provides a schematic block diagram of a component comprised of one or more Dynamic Food Bolts and/or Ingredient Building Blocks, according to an embodiment of the present disclosure.

FIG. 4 provides a flow diagram of an exemplary conditioning protocol to create a meal derived from components, according to an embodiment of the present disclosure.

FIG. 5 shows a block diagram of an exemplary process of building a conditioning protocol, according to an embodiment of the present disclosure;

FIG. 6 shows an exemplary block diagram of various meal components, according to an embodiment of the present disclosure.

FIGS. 7A-7D show an exemplary block diagram of how various components can be combined to produce different meals, according to an embodiment of the present disclosure.

FIGS. 8A-8B shows an exemplary block diagram of different elements of a conditioning protocol, according to an exemplary embodiment of the present disclosure.

FIGS. 9A-9B shows an exemplary meal preparation as compared between a beginner food preparer and an expert food preparer, according to an embodiment of the present disclosure.

FIG. 10A shows an exemplary cook program generation module, according to an embodiment of the present disclosure.

FIG. 10B shows an exemplary context aware module for altering a conditioning protocol based on user input and/or a user profile, according to an embodiment of the present disclosure.

FIG. 10C shows an exemplary user profile module, according to an embodiment of the present disclosure.

FIG. 10D shows an exemplary system, according to an embodiment of the present disclosure.

FIG. 10E shows an exemplary meal customization module, according to an embodiment of the present disclosure.

FIG. 10F shows additional elements of an exemplary meal customization module, according to an embodiment of the present disclosure.

FIG. 10G shows an exemplary system for executing a conditioning protocol, according to an embodiment of the present disclosure.

FIG. 11 shows an exemplary methodology, according to an embodiment of the present disclosure.

### DETAILED DESCRIPTION

The present disclosure provides for a conditioning program which provides the food preparers with options provided based on what ingredients and accessories they have available, dietary and health concerns and their preferences.

The invention is a complete new system and method whereby conditioning programs are based on Food Building Blocks (FBBs). FBBs are a combination of multiple variables such as but not limited to an ingredient, ingredient and state, conditioning techniques and processes and its structured content, that will be uniquely integrated based on consumer preferences. The combination of two or more Food Building Blocks make up a Dynamic Food Bolt (DFB) in this new digital dynamic and adaptive approach to conditioning programs.

### Dynamic and Adaptive Conditioning

Dynamic and adaptive conditioning programs take advantage of the fact it is easier to follow, more flexible, cost effective and versatile than to prepare and condition nutritional substances by just following a traditional static conditioning program. This new approach of creating conditioning protocols displayed in digital media such as mobile and computer applications, breaks down the protocols into basic units, called building blocks. Each building block contains a unique list of ingredients, tools and techniques, content or media, and appliances required to construct the building block. An example of building block from the culinary standpoint can be an ingredient (ingredient building block), a utensil or conditioner (technique building block) or the video or text instructions to prepare the ingredient (content building block). These building blocks are not unique and specific to just one conditioning protocol, that is, they can be shared among multiple dynamic and adaptive conditioning protocols. The building blocks, combined with other building blocks, create a Dynamic Food Bolt. Examples of dynamic food bolts can be diced tomatoes, sliced onions, squeezed lime juice. The table below illustrates the how the Dynamic Food Bolts are composed of ingredients, technique and content building blocks.

TABLE 1
Exemplary Building Blocks

| | Ingredient | | |
|---|---|---|---|
| Dynamic | Building | Technique Building | Content Building |
| Food Bolt | Block | Block | Block |
| Diced | Roma | Knife, Cutting Board - | Video and/or text |
| tomatoes | Tomatoes | Dicing (action) | illustrating prepara- |
| (Roma) | | | tion (washing) and |
| | | | dicing technique of |
| | | | tomatoes |
| Chopped | White | Knife, Cutting Board - | Video and/or text |
| onions | Onions | Chopping (action) | illustrating prepara- |
| (White) | | | tion (peeling external |
| | | | core) and slicing |
| | | | technique of onions |
| Squeezed | Lime | Knife, Cutting Board - | Video and/or text |
| lime juice | | Halving (action) | illustrating prepara- |
| | | Juice Extractor, | tion (washing) and |
| | | Container - Squeezing | halving and squeezing |
| | | (action). | technique of limes. |

The Ingredient Building Blocks may also contain nutritional information, which are then carried over at the Dynamic Food Bolt level. Besides nutritional information, the Dynamic Food Bolt also contains information about the conditioning intervention time or percent of time the user or food preparer is active in the conditioning process. The conditioning intervention time depends on both the type of task and the skill of the meal preparer. The conditioning intervention time are estimated for both simple and active tasks. Simple tasks such as turning on a conditioner or adding water to a pot are independent of the skill of the food preparer. Active tasks, such as chopping, dicing and peeling are dependent on skill; a skilled food preparer such as a chef do things significantly faster than a beginner in the culinary arts. Other tasks, not included in the conditioning intervention time, are considered idle, such as waiting for a conditioner to condition a given Component. Therefore, the Dynamic Food Bolt may also contain information on estimated times of simple and idle times with are independent of the skills of the food preparer. It may also include time estimations of active tasks as executed by a beginner, intermediate and expert food preparer.

A Component within a one or more conditioning programs can be made up of a combination of Ingredient Building Blocks and Dynamic Food Bolts, along with additional Component Technique and Component Content building blocks to prepare, assemble and/or condition the Component. By the way of example, a Component called Pico de Gallo Salsa is composed of the previously described Dynamic Food Bolts: 1 oz Diced tomatoes, 1 oz Chopped Onions, 1 tablespoon of Squeezed Lime Juice, along with 1 oz Chopped Green Pepper Dynamic Dynamic Food Bolt. The Component Technique Building Block involves mixing all the aforementioned Dynamic Food Bolts in a container with a fork, and the Component Content Building Block is comprised of text, video or pictures describing the mixing process of the Dynamic Food Bolts and utensils used. As the Dynamic Food Bolt, the Component comprises nutritional information and may also contain information on estimated times of simple and idle times with are independent of the skills of the food preparer. It may also include time estimations of active tasks as executed by a beginner, intermediate and expert food preparer.

A Meal is the end result of the execution of the adaptive and conditioning protocol and it is made up of one or a combination of two or more Components. For instance, “Grilled Chicken Breast Tacos with Pico de Gallo Salsa” is made up of the three Components: Grilled Chicken Breast, Warmed Tortillas and Pico de Gallo Salsa, along with plating instructions. A Building Block, a Food Bolt, or a Component used in one conditioning program can be used in other conditioning programs, so all the work, expenditures and time required to generate the building block is only done once. In the example, the Grilled Chicken Breast Component can not only be used in the Meal “Grilled Chicken Breast Tacos with Pico de Gallo”, but also in the Meals “Grilled Chicken Breast Salad with Ranch Salad Dressing”, “Grilled Chicken Breast with Roasted Broccoli and Tzatziki Sauce”. Hence, the content of a building block, Dynamic Food Bolt or a Component can be then “stitched” to other building blocks, which at the same time can serve as building blocks to other conditioning protocols. This is in contrast with traditional conditioning programs for which scaling is very expensive and cumbersome.

Another advantage of this approach is the facilitation of the Meal orchestration within the conditioning protocol in order to optimize the conditioning process by customizing the sequencing of the building block, Dynamic Food Bolts and Components and obtain a fast and efficient preparation of the meal. Meals generated from dynamic and adaptive conditioning programs include aggregated nutritional information derived from those Components that make up the Meal, and the estimates of simple, active and idle tasks. The orchestration of activities takes place at the Meal level, as the sequence of idle, simple and active tasks within the different Components are organized for the most efficient execution of the Meal.

Furthermore, dynamic and adaptive conditioning programs allow the customization of content for different nutritional substance transformers such as Fast-Moving-Consumer-Good (FMCGs) or conditioning equipment manufacturers. One of the key advantages of this approach is that only the building blocks, Dynamic Food Bolts or Components that require customization are replaced, rather than the entire content. For instance, the diced tomatoes Dynamic Food Bolt can be replaced by pre-diced tomatoes from a can purchased at a grocery store. Therefore, the dynamic and adaptive conditioning programs can comprise Dynamic Food Bolts or Components either made from scratch or purchased Dynamic Food Bolts. In this manner, conditioning programs displayed in digital form can be sponsored by FMCGs. Dynamic Food Bolts and Components purchased in the store, such as frozen items, may impact the Technique and Content Building Blocks as different conditioning parameters might be required, such as adding a thawing step for Frozen Dynamic Food Bolts.

Assuming that a conditioner manufacturer requests that their equipment and conditioning procedures are showcased in a given dynamic and adaptive conditioning protocol, only the building blocks that pertained to conditioning will be replaced and the new building blocks will be “stitched” to the conditioning protocol. In this case, if the conditioning protocol was made up of 20 building blocks and only 2 pertain to conditioning, there is no need to rework 18 out of the 20 building blocks, only 2 will be customized. This represents reworking 10% of the content with this novel approach, compared to 100% of rework needed to customize a traditional conditioning program.

As a way of example, in the Meal “Grilled Chicken Breast Tacos with Pico de Gallo”, let's assume that the Component Technique Building Block calls for a generic conditioner, which utilizes Bake at 425° F. A conditioner or appliance manufacturer might want to showcase this Meal with Components designed for specific conditioner with differentiated conditioning modes. Given that the only Component that is affected by the type of conditioner is Grilled Chicken Breast, the Components Warm Tortillas and Pico de Gallo are not modified. The Grilled Chicken Breast is made up of Black Pepper (Ingredient Building Block), Olive Oil (Ingredient Building Block), Salt (Ingredient Building Block), Squeezed Lemon Juice (Dynamic Food Bolt) and Boneless Skinless Chicken Breasts and including the Component Technique Building Block (Conditioner type—conditioning) and Component Content Building Block (Video and Text Instructions, including the seasoning step and conditioner parameters such as conditioning mode, time and temperature). As the only Component Building Blocks that are impacted by the type of conditioner are the Technique and Content, they are replaced by the conditioner specific content.

The same approach can be followed with other conditioner manufacturers for the same Meal. So different versions of the same dynamic and adaptive conditioning program are made available without replacing the entire content. Furthermore, if the dynamic and adaptive conditioning program is displayed in a computer or in an app in a mobile device, a filter can be applied so as to only display conditioning programs designed for the conditioner that the meal preparer is using.

In addition, the skill of the user is taken into account when “stitching” the food building blocks as this will influence the way the multi component meal is orchestrated. To orchestrate Meals derived from dynamic and adaptive conditioning programs, it is important to understand when all the tasks, simple, idle or active, begin and when they end within the Components within the Meal. The sequence of the execution of the Components can be organized in series, which is not always the most efficient but necessary when the Components are interdependent. For instance, in the preparation of a stir fry Meal, some Components are added first, and others last in the same frying pan where the Components are mixed and conditioned.

In other cases; however, Components are independent of each other, so certain activities from multiple Components should be executed in parallel in order that the Components are conditioned at the same time and obtained the most efficiency. Executing Component in series when they are independent may also impact the quality of the meal, as the Component that was conditioned first will be cold or “dry” when the second Component is conditioned. Ideally, conditioning of the multiple Components should end at the same time, right before plating, so the organoleptic properties of the Meal are optimum.

The orchestration of activities of the different Components in parallel is usually done when there are one or more idle tasks in one or more components, that can be overlapped. For instance, one task in the BBQ Baby Back Rib Component is to condition ribs in an oven while at the same time water is boiling in a pot for the Boiled Quinoa Component, as both tasks can be considered idle tasks. This allows the food preparer to engage in an active activity simultaneously, such as chopping lettuce for the Salad Component. However, two active tasks cannot take place simultaneously, assuming that there is only one food preparer. Furthermore, the orchestration can be affected by the skill or number of food preparers, as this can impact the beginning to end duration of a Component.

In general, this approach could apply to any number of ingredients and conditioning standard methods to ingredients that are similar in the culinary sense: roasting a chicken, for example; marinating and grilling a beef sirloin is like marinating and grilling chicken breast; preparing sauces, making pizza or frittata has an endless number of variations or toppings; making pasta or risotto.

Other advantages and features will become apparent from the following description and claims. It should be understood that the description and specific examples are intended for purposes of illustration only and not intended to limit the scope of the present disclosure.

### Food Building Blocks (FBB) are the Basis for Dynamic Food Bolts (DFB)

In some embodiments, there are generally four types of Food Building Blocks, comprised of: Ingredients Building Block (IBB), Tools and Technique Building Block (TTBB) and Content Building Block (CBB).

The IBB is the basic form of FBB, which is the actual ingredient and its state. It can be as simple as salt, pepper, olive oil or as complex as a frozen pizza purchased in a supermarket.

The Technique & Tools Building Block (TTBB) is the culinary technique used to prepare the ingredients and the kitchen tools (utensils) require for their preparation. It can be slicing, dicing, chopping, mashing, boiling, etc, amongst other techniques, and the tools can be, but not limited to, a knife, a pot, a spatula, box grater, amongst others. It can also include the type of conditioner or instrument powered by gas and/or electric power used to perform a function or technique such as baking, blending, broiling, searing. Examples of appliances include, but are not limited to, blenders, gas and electric cooktops, gas and electric ovens, mixers, food processors, electronic scales, amongst others.

The Content Building Block (CBB) is where the digital content is stored in different digital media formats, such as, but not limited to, video, audio (voice), pictures, text and weblinks, amongst others.

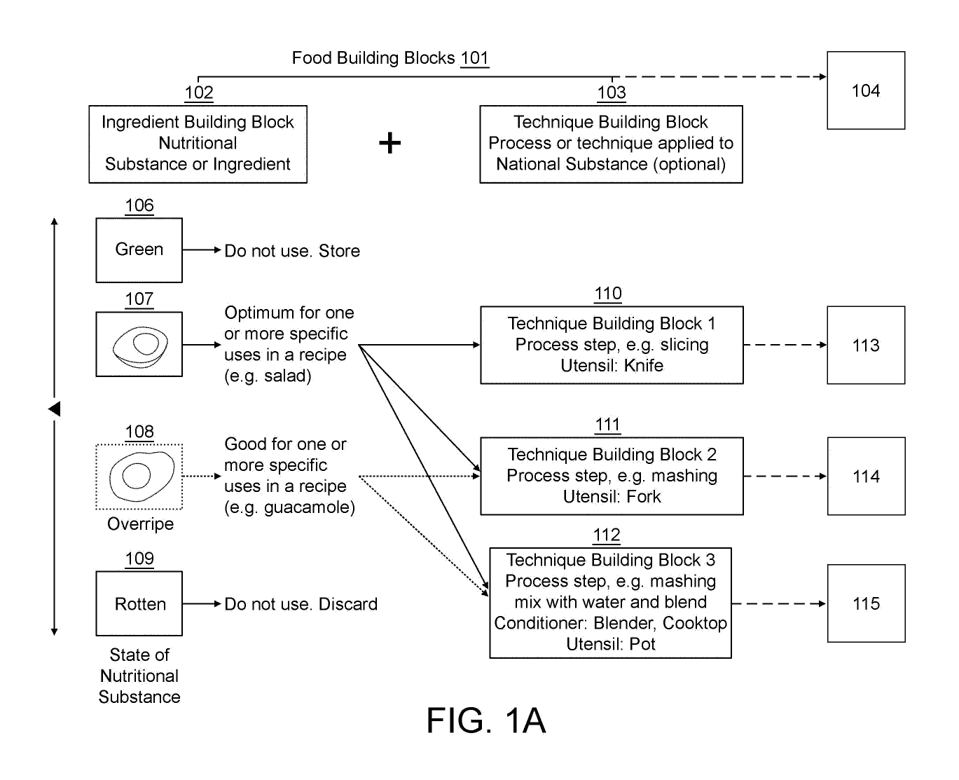

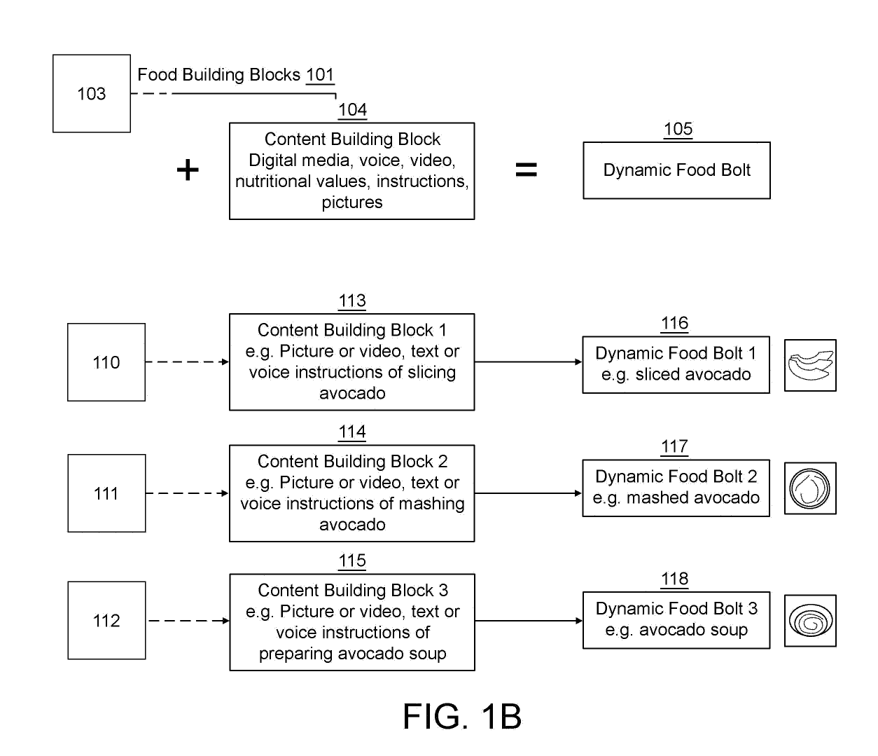

FIGS. 1A-1B illustrate a schematic flow/block diagram illustrating how different Food Building Blocks (FBB) are integrated to form one or more Dynamic Food Bolts (DFB) according to embodiments of the present disclosure. The example illustrated in FIGS. 1A-1B, show how the different Food Building Blocks 101 integrate to form one or more Dynamic Food Bolts 105. In this example, an avocado is the Ingredient Building Block 102, with a state based on its level of maturity (ΔN). For illustration purposes, the state of the avocado the meal preparer has at hand can be either green 106, ripe 107, overripe 108 or rotten 109. The digital media, part of the Content Building Block 113, 114, or 115 used to provide conditioning instructions, can also indicate how to assess the state of the nutritional substance (either through visual and tactile means, or through sensors such as but not limited to Near Infrared Spectroscopy, cameras, heat sensors, or other similar sensor technologies). The state of the green avocado 106 is not ready yet to be cooked or eaten, so the food preparer should wait until it reaches sufficient maturity and stored for a period of time. A rotten avocado 109 should be discarded. In this example, only the ripe 107 and overripe avocado 108 can be used to create a Dynamic Food Bolt 105. The avocado that has reached sufficient maturity (ΔN), or it is just ripe 107, can be sliced 110 or mashed 111, actions which are part of the Technique & Tools Building Block 103. The Content Building Block 104 can be in the form of combined digital media; for instance, a video showing how the avocado is sliced 113, and/or text and/or voice instructions of the slicing execution and/or nutritional content of the avocado. In this example, a knife utensil is used, as stated in the Technique Building Block 110. The result of combining these Food Building Blocks 101 is the creation of the “Sliced Avocado” Dynamic Food Bolt 116.

Referring again to FIGS. 1A-1B, another Dynamic Food Bolt 105 that can be created is “Mashed Avocado”, in which the ripe 107 or overripe avocado 108 can be used as part of the Ingredient Building Block 102. The overripe avocado 108 might have brown areas that need to be removed, so it cannot be prepared as sliced avocado given that it is not visually appealing. In this case, mashing can be done with a conditioner (e.g. food processor) or with a utensil (fork). For illustration purposes, it is assumed that a fork is used as the food preparer does not have a food processor, so the digital media will provide instruction for manual mashing and the Technique & Content Building Blocks (111, 114) describing that a conditioner is not used. The action to mash the avocado is part of the Technique Building Block 111. Therefore, the state of maturity of a raw ingredient must be considered when determining the type of Dynamic Food Bolt 106 that can be created. In this case, the “Mashed Avocado” Dynamic Building Block 121 can be generated with either ripe 107 or an overripe 108 avocados.

Another example illustrates the adaptability of the conditioning program to the type of conditioners or appliances available, part of the Technique Building Block. In this example, the ripe or overripe avocado (107 or 108) can be used as an Ingredient Building Block 102 to generate the “Avocado Soup” Dynamic Food Bolt 118. The Content Building Block 115 can be part of the digital media presented and explained in previous examples, and indicates the type of conditioner to use. If the user does not have a conditioner such as a blender with heating capabilities, the instructions will require that the mashing of the overripe avocado 108 is done by hand adding water and heating the mixture in a pot on a conditioner, e.g. a cooktop. In this case, the Technique & Content Building Blocks will indicate the type of utensils. If, on the other hand, the user inputs that he/she has such conditioner, then the instructions will indicate the settings of the conditioner, such as blending speed, temperature and time. In addition, the Technique & Content Building Block (112 & 115) will indicate that two conditioners (e.g. blender and cooktop), and the type of utensil (e.g pot). Furthermore, if the food preparer indicates that they have one or more connected conditioner to the cloud via WiFi or Bluetooth thorough a mobile device, the application will automatically send the settings directly to the conditioner at the time prescribed by the dynamic and adaptive conditioning program, so all the food preparer has to do is to start the conditioner from the application. This is further explained in the Filters section.

### Dynamic Food Bolts, Ingredient Building Blocks as the Basis for Components

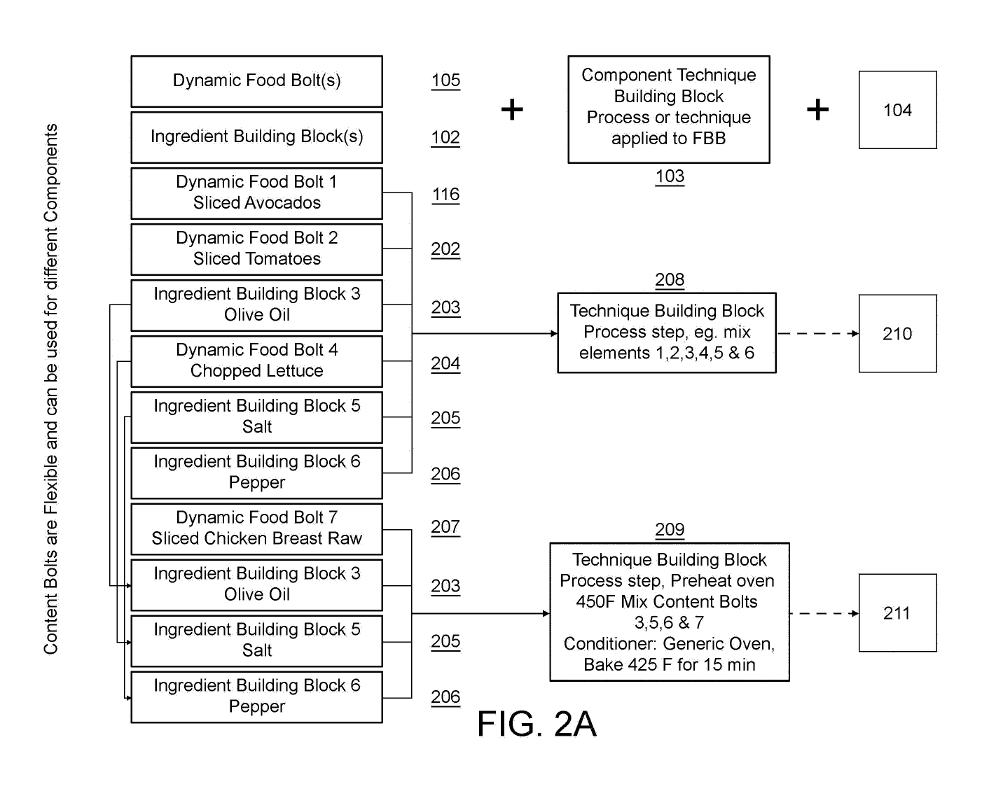

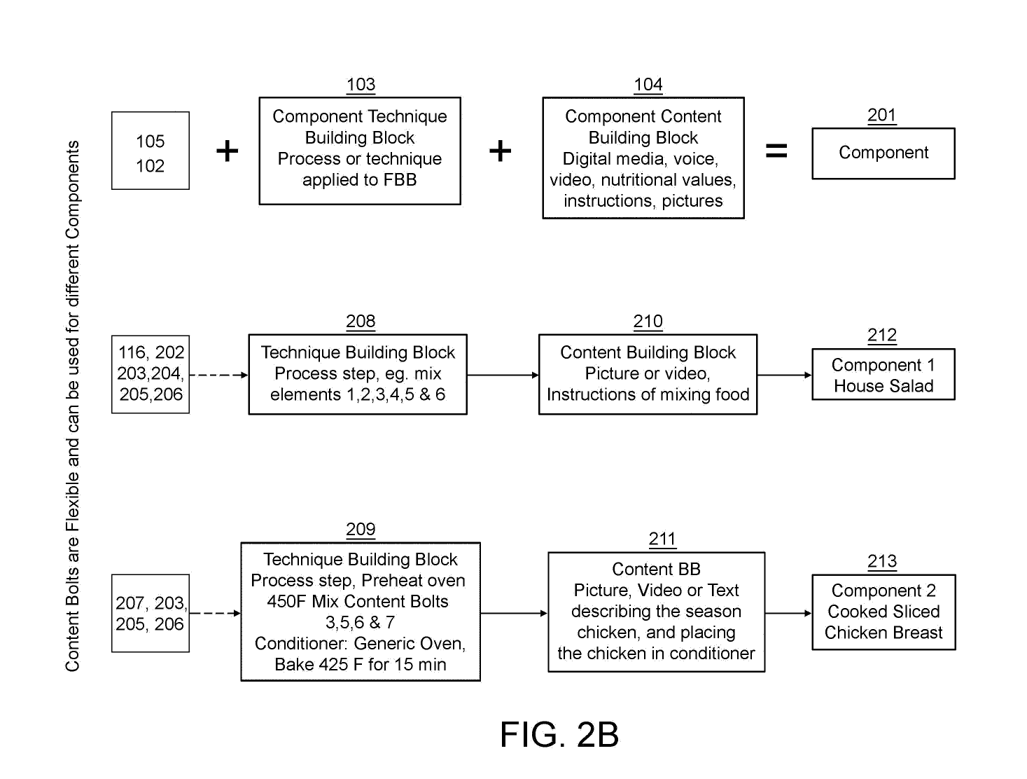

In some embodiments, a Component is generally comprised of a combination of Dynamic Food Bolts and Ingredient Building Blocks, combined with a Technique Building Block and a Content Building Blocks. FIGS. 2A-2B are a schematic block diagram illustrating Components comprised of a combination of Dynamic Food Bolts (105) and Ingredient Building Blocks (102) which may be combined with Component Technique Building Blocks (103) and Content Building Blocks (104) according to embodiments of the present disclosure. For example, as shown in FIGS. 2A-2B, the Dynamic Food Bolt 1, sliced avocado 116; the Dynamic Food Bolt 2, sliced tomatoes 202; the Ingredient Building Block 3, olive oil 203; the Dynamic Food Bolt 4, chopped lettuce 204; Ingredient Building Block 5, salt 205; and the Ingredient Building Block 6, pepper 206, are mixed per Component Technique Building Block 208 to create a house salad Component 212 (Component 1). This component does not involve a conditioner, so the Technique Building Block 208 does not include one. In a dynamic and adaptive approach, one or more Dynamic Food Bolts 105 and Ingredient Building Blocks 102 can also be used as a building block for other Components 201. For instance, Component 2 213 also uses Ingredient Building Blocks 3, olive oil 203; Ingredient Building Block 5, salt 205; and Ingredient Building Block 6, pepper 206. The combination of Dynamic Food Bolt (207) and Ingredient Building Blocks 203, 205, 206, along with the Component Technique Building Block 209 and Component Content Building Block 211, create the Component 2 “Cooked Sliced Chicken Breast” 213. It is important to note that the creation of this Component requires a conditioner, so the Component Technique & Content Building Blocks 213 indicates a generic conditioner.

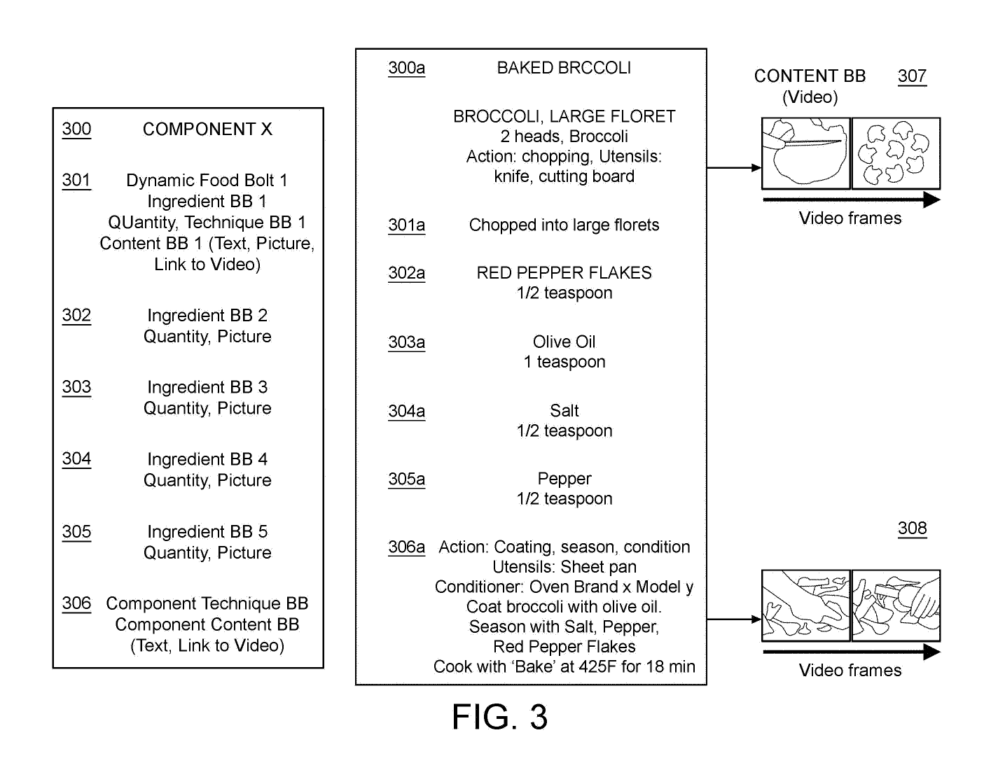

FIG. 3 is an example of how the Dynamic Food Bolts and Components can be displayed in a digital form, e.g. computer or mobile app, or in the internet via a browser. The display shows how the Component X 300 is broken down into a Dynamic Food Bolt 1 301 and Ingredient Building Block (302-305), along with its corresponding Technique & Content Building Blocks 306.

In addition, this example includes a specific example of how the Component Baked Broccoli 300a may be displayed in a screen of the app. The Dynamic Food Bolt 301a is composed of 2 broccoli heads chopped into large florets, along with its corresponding Ingredient Building Block “2 heads of broccoli” and picture; its Technique Building Block of Chopping (action) using a knife and cutting board (utensils), and its Content Building Block including the preparation instructions “Chopped into large florets” and a video 307.

Additional food items and their corresponding quantity and optional descriptor (picture) are part of the Ingredient Building Block, which include red pepper flakes 302a, olive oil 303a, salt 304a and pepper 305a. Furthermore, the Component Baked Broccoli 300a includes its Component Technique Building Block 306a describing the actions of coating and conditioning, the utensils required to condition (sheet pan) and the type of conditioner, which in this case describing an oven make and model. It is important to note that the actions of the Technique Building Block are used in the database as descriptor and therefore not displayed in the app as such. The video Content Building Blocks for both the Dynamic Food Bolt, 307 or the Component 308 can be accessed either by a link on a specific area anywhere on the screen or using voice commands via a voice assistant.

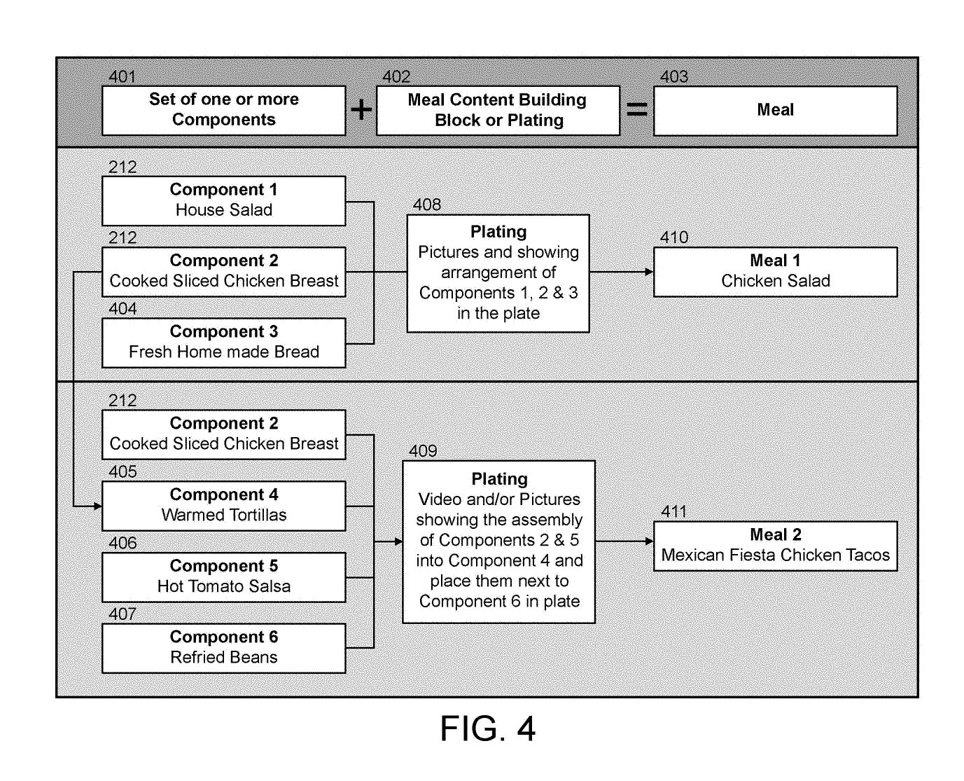

As illustrated in FIG. 4, in some embodiments a Meal 403 is generally comprised of or made up by one or more Components 401 combined in a plate 402. In this example Meal 1, “Chicken Salad” 410, is made up of Component 1, House Salad 212; Component 2, Cooked Sliced Chicken Breast 213; and Component 3, Fresh Home-Made Bread 404. These Components 401 can serve as the building blocks for other Meals 403. For instance, the “Cooked Sliced Chicken Breast” Component 212 used on Meal 1 410 is also used in the Meal “Mexican Fiesta Chicken Tacos” 411 in combination with Component 4, Warm Tortillas, 405; Component 5, Hot Tomato Salsa 406; and Component 6, Refried Beans 407. Plating 402 is the integration of the different Components into a plate, just before consumption, and it can be also considered as a Meal Content Building Block. The plating steps comprises content, mainly picture and videos, illustrating recommendations how the Components are to be placed to make it appealing to the consumer. For instance, Plating 408 illustrates in a picture the presentation of the Components in the plate, as the assembly is very simple and straight forward. Plating 409 is more involved than Plating 408 and thus requires more media content such as a video to better illustrate the assembly process of the meal.

### Filter 1: Consumer Aware/Customization Based on User Preferences

Another key benefit of the digital dynamic and adaptive platform of the present disclosure is that the food preparer can filter in or out Meals based on his/her preference, including but not limited to allergies (e.g. gluten, dairy, peanuts) and/or dietary preferences (paleo, pescatarian, vegetarian) and/or likes or dislikes (e.g. anchovies, garlic, onions). The application has a section for consumer preferences, where the user can input the allergies, intolerances and dietary preferences.

### Allergies and Intolerances

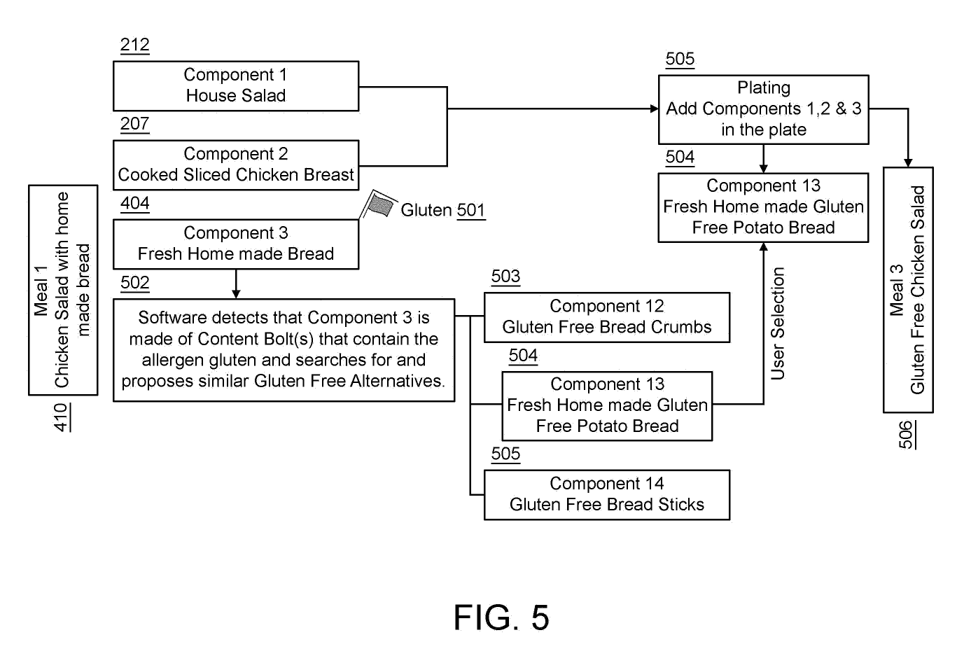

The dynamic and adaptive approach of building Meals or Conditioning programs facilitates the application algorithms to consider allergens that can cause from mild to severe allergies in certain consumers. For instance, referring to FIG. 5, if a consumer is intolerant to gluten and is searching for a “Chicken Salad with Homemade Bread” 410, the application will automatically detect gluten 501 in the Fresh Home made Bread Component 404 and will either: a) ignore this Meal or filter out, b) present the Meal 410 with a flag 501 that Component 404 contains gluten or c) present the Meal 410 flagging gluten 501 and recommend substitutions, such as Gluten Free Bread Crumbs Component 503, Fresh Homemade Gluten Free Potato Bread Component 504, or Gluten Free Bread Sticks Component 505. These are Components similar or compatible with the Fresh Homemade Bread Component 404. These substitutions can be displayed in the app so the food preparer or consumer can select their preference. Once the selection is made, the Component Home Made Fresh Bread 404 will be replaced for the selected gluten free Component. The software will automatically add the “Gluten Free Chicken Salad” Meal 506 to the user preferences so the application can remember this Meal in the favorites or previously conditioned section in the app. This way, the new Meal can be retrieved and displayed with the substitution whenever this specific user or consumer searches for chicken salads so that the Meal “Gluten Free Chicken Salad” 506 will be display on top of the list of Meals comprising chicken salads.

### Dietary Preferences

Handling conditioning programs with dietary preferences is approached in a similar manner as the one for allergies. If the user selects “Pescatarian” as a dietary preference, all Components containing beef, chicken, veal, lamb, and pork (and other non-fish meats) will be filtered out, so only the Meals with Components options containing Fish or Vegetarian will be available in the application. Another approach as described above is to either display Meals containing meat with a flag, and/or propose substitutions for the meat containing Components.

### Filter 2: Appliance Aware Through Appliance Building Block: Customization Based on User Access to Conditioner Aware

There are significant number of types of conditioners in today's marketplace, including but not limited to blenders, ovens, cooktops, refrigerators and food processors. Conditioners perform different functions in the preparation of Dynamic Food Bolts, Components, and Meals. For instance, a blender can mix, purée, emulsify or heat (if the blender has heating capabilities) food and other substances; ovens, grills, or waffle irons cook food items to bring about chemical changes, resulting in organoleptic, nutritional and aesthetic changes in the food; a food processor quickly and easily chops, slices, shreds, grinds, and purees almost any food.

In the application, the consumer indicates what type of appliances are available in his/her kitchen, as saved in the consumer or food preparer profile. This is important, as the instructions will adapt to what type of conditioners are available to the food preparer. The type of conditioners that the application can filter in or out are, but not limited to, food processor, blenders, blenders with heating capabilities, waffle irons, and grills, among others. For example, if the user does not have a blender with integrated heating capabilities as indicated in the user's profile, conditioning programs that require such appliance will either be adapted so the user can use a blender to mix the ingredients plus a pot to heat up the mixture. On the other hand, if a recipe such as Whole Turkey Meal requires an oven, and the application detects that the user does not have an oven, this Meal selection can be filtered out.

Beyond filtering out by type of appliances (e.g. oven, cooktop, food processor), the conditioning program can be adapted based not only on the type of appliance, but also the brand, make and model of the appliance. There are design and conditioning performance differences between conditioners, given that there is a wide variety of brands and models of conditioning systems that are fabricated by the same or different manufacturers with different specifications. Typically, each conditioning model will vary in many ways, such as in shape, heating power, conditioning chamber volume, number and type of conditioning elements, and the number and type of sensors, amongst other technical differences.

For instance, a conditioner manufactured by brand A and model “abc”, can have a volume capacity of 1.1 cubic feet and contain two conditioning elements (e.g. 1.5 kW broil and 1.2 kW convection), whereas a second conditioner, manufactured by brand B and model “fge” can have a capacity of 1.5 cubic feet and contain three conditioning elements with power (e.g. 1.1 kW bake, 1.3 kW broil and 0.5 kW convection). Each model is designed and manufactured according to a technical specification determined by the manufacturer of the conditioner.

A conditioning protocol is hereby defined as the set of instructions that are send to the conditioner controller for execution the conditioning of the food item or nutritional substance. In addition, the conditioning protocols for one or more conditioners can be stored on either a local or remote database and referenced to the nutritional substance.

For instance, if there are two conditioners of the same type manufactured by two different brands or two conditioners manufactured by the same brand with different model number and conditioning specifications, each conditioner will have different conditioning protocol for the same food item. If the case where the conditioners are two ovens, the conditioning protocol for the same food item or nutritional substance can be “traditional bake at 425 F for 30 min” for one oven (oven with no convection fan), whereas for the second oven can be “conventional bake at 375 F for 15 min” in the second oven (oven with convection fan). The conditioning time for both conditioners is different and considered an idle task. Hence, this impact the conditioning timing of the Component that comprises an oven for conditioning, but it may or may not impact the overall timing for the execution of the conditioning programs. This depends on whether or not other Components making up the Meal are executed in series or in parallel and how much overlap there is between Components. The Component overlap depends on the level of number and complexity of the Components to be orchestrated within the Meal, how many active task are involved and the skill level of the food preparer.

The same logic applies to other conditioning types. For instance, a blender X made by manufacturer A might provide more speed than a blender Y provided by manufacturer B. In this case, the conditioning time for blender X may be shorter to blender Y, which will impact the timing for an idle task.

The information of the make and model is stored in the Component Technique Building block of the Conditioning Program, with the time corresponding idle, active, and simple task. Idle tasks in a Dynamic Food Bolt or a Component are those in which there is no intervention required by the food preparer and hence are not impacted by the skill of the user. For example, the tasks that are performed automatically by a conditioner, or items that require a resting time such as marinating and proofing dough. Simple tasks involve minimum involvement of the food preparer and are independent of the skill of the user. Examples of simple tasks are pushing a button to start a conditioner, mixing ingredients, and seasoning. Active tasks require significant involvement of the food preparer, tasks such as chopping, mincing, zesting and stretching dough. The timing for the active tasks is estimated based on the skill level of the food preparer. The time estimation and orchestration of a dynamic and adaptive conditioning program is further explained on a subsequent section of this description.

Flexibility and Versatility in the Number of Meals that can be Generated Using a Dynamic and Adaptive Approach

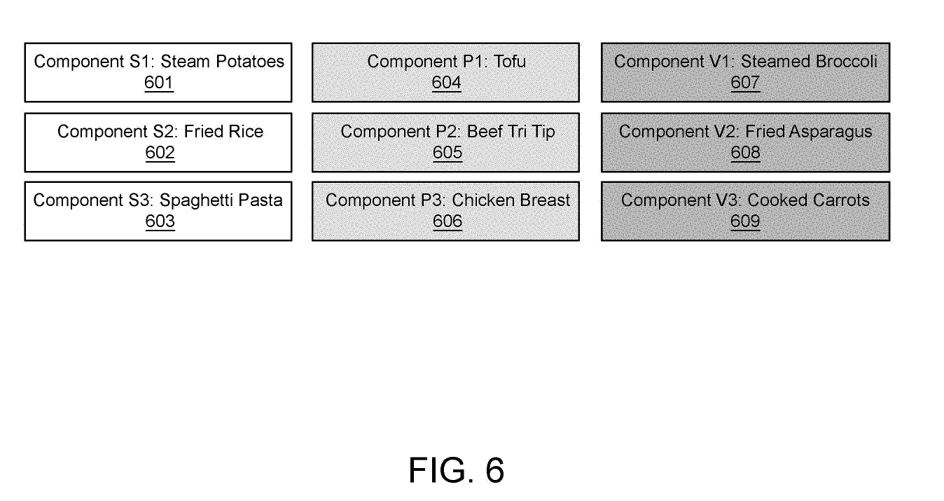

The dynamic and adaptive nature of the building block allows an embodiment of the present disclosure to combine an infinite number of Content Building Blocks and Components to generate an infinite number of Meals. FIG. 6 for example, shows the number of Meal Combinations that can be obtained for a set of nine (9) Components; where the set is made up of three protein based Components 604, 605, 606; three vegetable based Components 607, 608, 609; and three starch based Components 601, 602, 603. In the case where a Meal is composed by one protein Component, one vegetable Component and one starch Component, there are 27 possible Meal combinations. If the Meals were to be made up of 2 components, independent of type (starch, protein or vegetable), then the number of possibilities is based on the Equation 1:

$${}_{n}^{}{C}{}_{k}^{} = \frac{n !}{( n - k ) ! k !} . \qquad Equation 1$$

where n is the size of the set, C is the combination, k is the number of components selected, n! is the permutation of the full set, (n−k)! is the permutation of the left behind set, and k is the permutation of the selected set.

In this example, n is equal to 9 (the number of Components available), k is equal to 2 (the number of Components in a Meal), resulting in 36 combinations. If a Meal is made up of 1 Protein, 1 Vegetable and 1 Starch, the nine listed components can provide 27 combinations. The combinations are shown in below in Table 2 (“S” refers to Starch; “P” refers to Protein; “V” refers to Vegetable; “M” refers to Meal).

TABLE 2
Possible Meal Combinations

| # | Combination |
|---|---|
| 1 | M1 = S1 + P1 + V1 |
| 2 | M2 = S1 + P1 + V2 |
| 3 | M3 = S1 + P1 + V3 |
| 4 | M4 = S1 + P2 + V1 |
| 5 | M5 = S1 + P2 + V2 |
| 6 | M6 = S1 + P2 + V3 |
| 7 | M7 = S1 + P3 + V1 |
| 8 | M8 = S1 + P3 + V2 |
| 9 | M9 = S1 + P3 + V3 |
| 10 | M10 = S2 + P1 + V1 |
| 11 | M11 = S2 + P1 + V2 |
| 12 | M12 = S2 + P1 + V3 |
| 13 | M13 = S2 + P2 + V1 |
| 14 | M14 = S2 + P2 + V2 |
| 15 | M15 = S2 + P2 + V3 |
| 16 | M16 = S2 + P3 + V1 |
| 17 | M17 = S2 + P3 + V2 |
| 18 | M18 = S2 + P3 + V3 |
| 19 | M19 = S3 + P1 + V1 |
| 20 | M20 = S3 + P1 + V2 |
| 21 | M21 = S3 + P1 + V3 |
| 22 | M22 = S3 + P2 + V1 |
| 23 | M23 = S3 + P2 + V2 |
| 24 | M24 = S3 + P2 + V3 |
| 25 | M25 = S3 + P3 + V1 |
| 26 | M26 = S3 + P3 + V2 |
| 27 | M27 = S3 + P3 + V3 |

Generating content for Meals using Traditional Conditioning programs is very expensive and time consuming, as the entire content is specific to a conditioning program. In this example, generating content for each Meal can be up to 4-fold higher in terms of memory required, time and expenses generating that content, compared to the dynamic and adaptive approach, which only requires content at the Component level. The application can automatically incorporate the Components and generate 36 Meals, while the content required to generate them is 9 Components only. Likewise, generating content for the Components is further reduced in the dynamic and adaptive approach, as the content for the Food Building Block and Dynamic Food Bolts is generated only once, and this can be used in the creation of multiple Components.

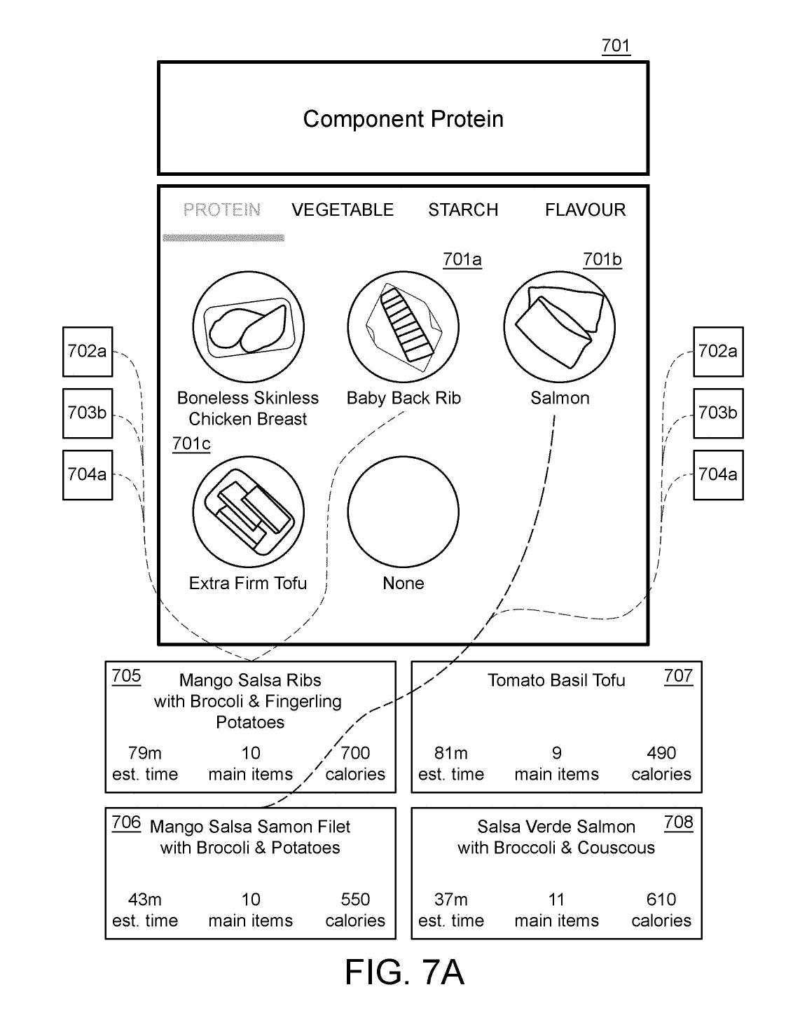

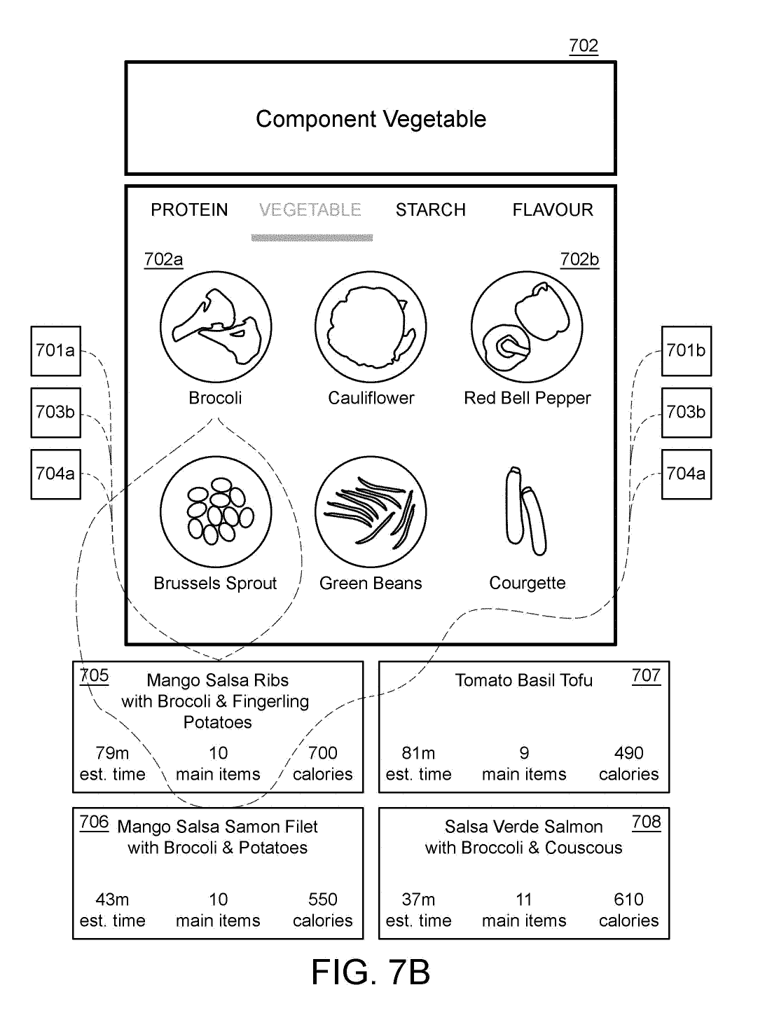

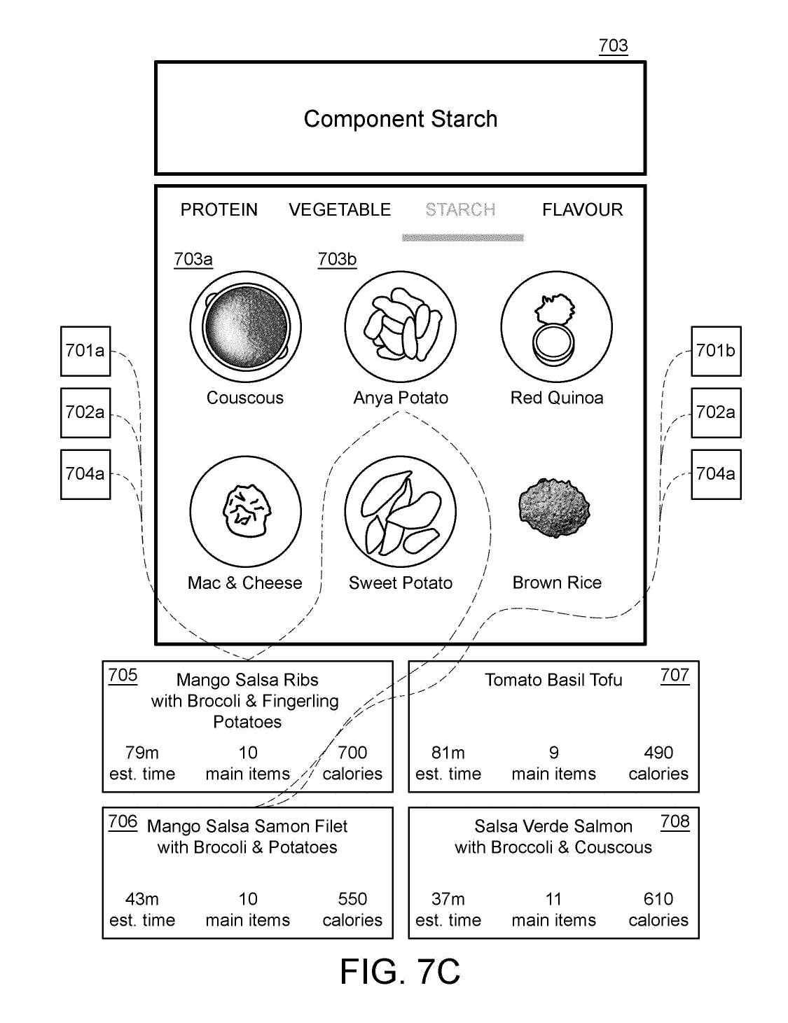

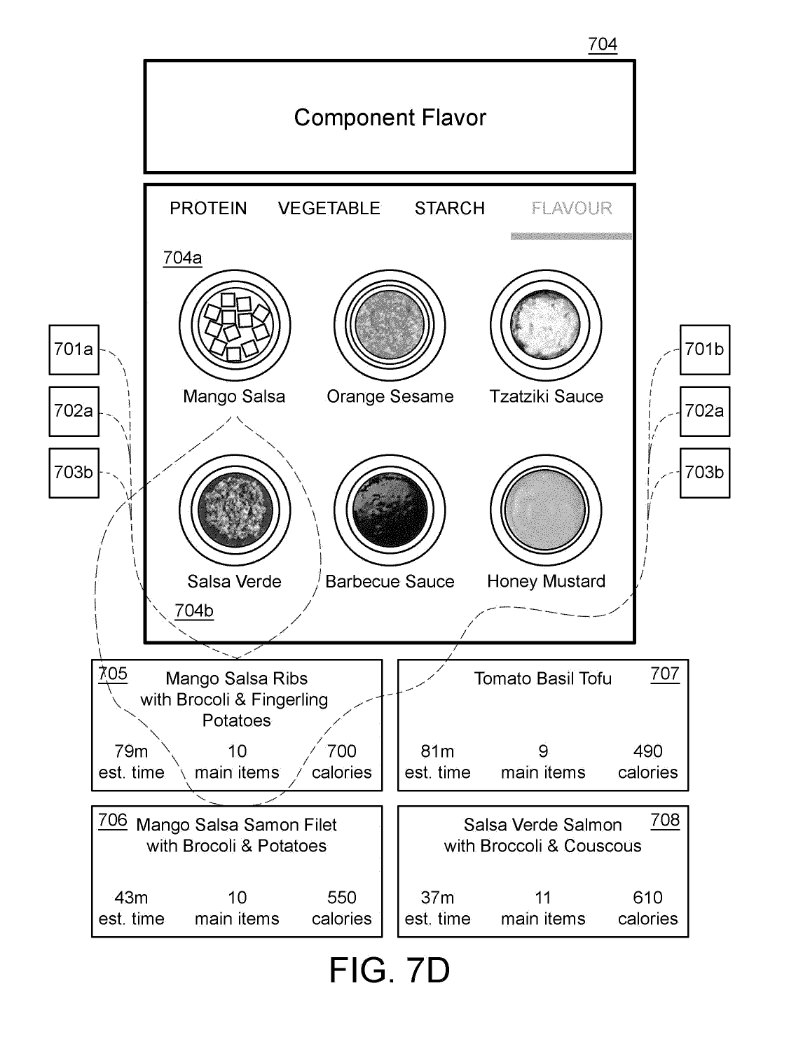

FIGS. 7A-7D. illustrate (1) how the different Meals can be built from different Components and (2) the effect of changing Components on the overall Meal time and nutritional values. In this example, the Meal can be built from 4 different Components: protein 701, vegetable 702, starch 703, and flavor 704. The protein 701 Component is made of 5 options, including Baby Back Ribs 701a and Salmon 701b; the vegetable 702 Component comprises 6 options; the starch 703 Component comprises 6 option; and the flavor 704 Component includes 6 options. Overall, the number of combination of Meals that can be obtained are 1,080.

Each Meal combination has an estimated time of execution for a food preparer with intermediate culinary skills, the number of ingredients required and the nutritional information. In this example, the nutritional information is viewed as the number of total calories, but it can also be further broken down into quantity of protein, fats, carbohydrates, trans fatty acids, sugars and added sugars, with units of measure in g, mg or % Recommended Daily Allowance (RDA). Changing one Component for another changes the execution time, number of ingredients and the nutritional information. To create the Meal “Mango Salsa Ribs with Broccoli and Potatoes” 705, the food preparer selects the one option per Component in the application, which are Baby Back Ribs 701a, Broccoli 702a, Potatoes 703b and Mango Salsa 704a. The app indicates this Meal takes 79 min, yields 700 calories and requires 10 main items or ingredients.

If the consumer or food preparer deems that the preparation time is too long or the caloric value too high, they can choose another combination. The user can change the combination manually or the app can provide a list of recommendations based on the calories desired, ingredients available, nutritional content or calories. Replacing Baby Back Ribs 701a with Salmon 701b generates a Meal “Mango Salsa with Broccoli and Potatoes” 706, will decrease the number of calories to 550 and the time to 43 min. The replacement can be performed manually by the user by pressing on Salmon or automatically recommended based on the consumer preferences. Other Meals can be generated by selecting different options in each Component, such “Salsa Verde Salmon with Broccoli and Couscous” 708 by choosing Salmon 701b, Red Bell Pepper 702b, Couscous 703a and Salsa Verde 704b.

### Tracking Dynamic and Adaptive Conditioning Programs and Time Estimation (Conditioning Navigation System)

The food preparer can input his/her culinary skill level in the Consumer or User Preferences Section of the application. There can be multiple levels of expertise that the system can use. In this example, the food preparer can select one of the three different levels defined: Beginner (no or little culinary expertise), Intermediate (fundamental culinary with some conditioning experience) and Expert (high level of culinary expertise). This is important because it allows the application to estimate the preparation time from a specific Dynamic Food Bolt to a specific Component and to ultimately estimate the overall time it takes to prepare the Meal selected by the food preparer or consumer. Besides optimizing the amount of content generated for Meals, the dynamic and adaptive approach can also allow the software to track the sequence of preparation and cooking events. The Technique Building Block, for each Dynamic Flavor Bolts and Components, contains digital media that includes an algorithm that arranges the building blocks in sequence or in parallel (based on the input of a culinary expert). This skill level of the user plus the estimated time per Dynamic Food Bolt and sequence of activities allows the rapid estimation of the time it takes to complete a Meal from beginning to end. As mentioned before, the estimation can consider the skills of the food preparer or consumer, since the Meal preparation time for an experienced cook can be significantly shorter than a person just introduced to the art of cooking. Time is an important factor for preparation orchestration of a Meal by sequencing in the right order the events in such a way that the Meal is ready in the shortest time possible. The estimated time to completion can be continuously updated as the user learns to cook. For instance, if the user took less time than estimated to complete a specific Dynamic Food Bolt or Content within a Meal, the estimated time to complete is updated with the new time. If on the other hand, the user took longer than expected, the estimated time to complete is increased. This can be achieved by using a multiplication factor on activities that depend on the skill of the user, which can be saved in the user profile. The dynamic and adaptive approach will also take into consideration how the food preparer is using the application and if the estimated time needs to be adjusted, as the user could have under or overestimated his/her skill level. The application can add a factor, specific to the user, to compensate for this miscalculation. In the future the application will “learn” the user's skill level with more accuracy. It can also autocorrect for the skill level of the user as his/her skills improve over time.

The time estimate at the Dynamic Flavor Bolt level is by timing the process of processing the basic or raw nutritional substance or ingredient. A culinary expert determines time estimates for preparing a specific Dynamic Flavor Bolt from basic ingredients. It can consider different levels of culinary expertise. The user can input his culinary expertise so the time estimates provided in the Recipe reflect the best estimate as possible. These time estimates are the basis for the time estimate for every Component.

The time estimate at the Component level considers the time that it takes to aggregate each Content Building Block either in series or in parallel, depending on input of the culinary expert and the skills of the food preparer. When a Component is made up of two or more Dynamic Flavor Bolts, a culinary expert determines the order of preparation of the Dynamic Flavor Bolts, which ones are processed in parallel and which ones in sequential order. The Component is set up in the software as a time sequence diagram, which shows the order and the time to prepare a specific Component. When a conditioning or preparation process is required, it is also included in the time sequence diagram.

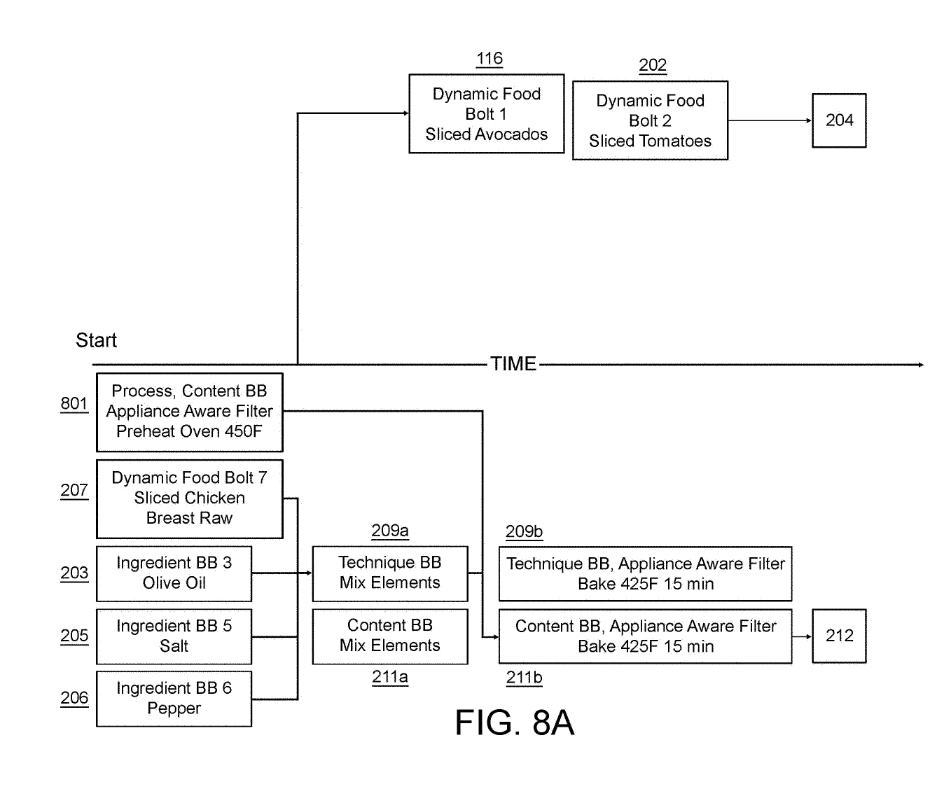

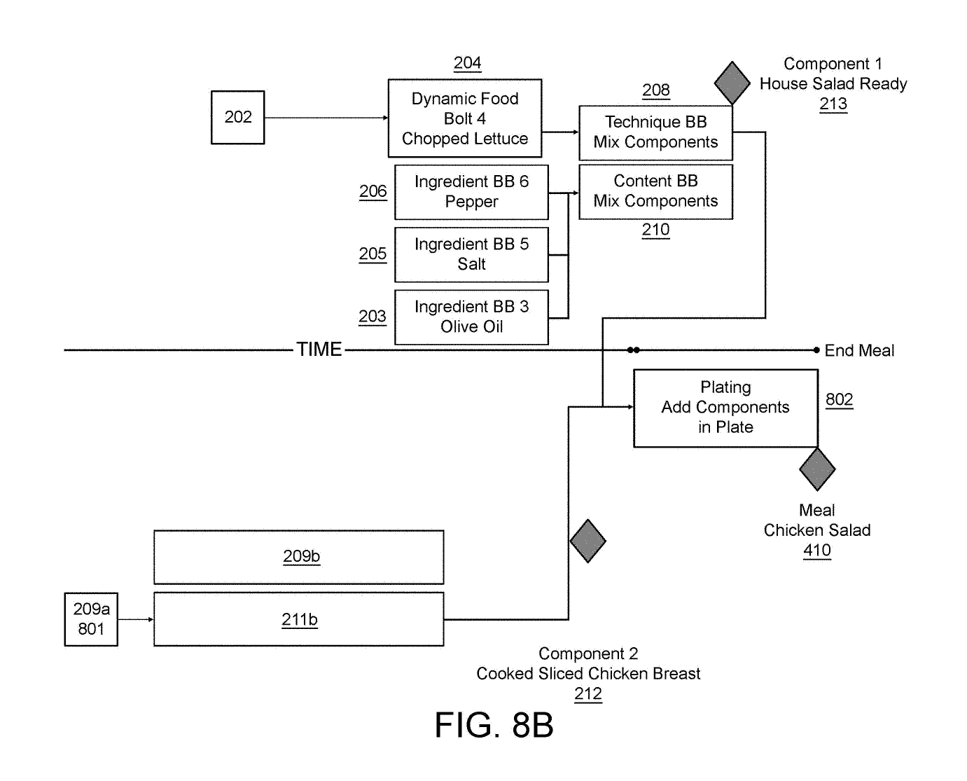

The overall time estimate of the meal as illustrated in FIGS. 8A-8B includes the time for the interwoven preparation of two Components. In this case, the House Salad 212 and the Cooked Sliced Chicken Breast 207 are prepared based on an optimum sequence and time estimation per element or building block determined by the culinary skill of the user when required. Some processes or tasks are independent of the skill of the food preparer, such as preheating the conditioner or conditioning the nutritional substance in the conditioner (idle tasks).

In this example, the processes are set up by the culinary expert developing the conditioning protocol. The first step is to compare the time it takes to prepare each Component, the House Salad 213 versus the Cooked Sliced Chicken Breast 212. As cooking the sliced chicken breast takes the longest, orchestration of the different components in the Meal 802 will be dictated mainly by this Component. The first step is to Preheat the Conditioner 801, as this step is in the critical path of preparation the Component. In parallel, the Dynamic Food Bolt “Sliced Chicken Breast Raw” 207 is prepared, and all the Food Building Blocks are mixed per Technique Building Block 209a and corresponding Content 211b.

Once this step is finalized and the conditioner preheated, the food preparer places the Food Building Blocks inside the conditioner described in Technique Building Block 209b, with its corresponding Content 211b.

After this step is completed, the time to start the preparation of the House Salad Component 213 is determined by the application, in such a way that both components are ready at the same time. In this example, it is important to start the preparation of the Component 213 immediately after the Food Building Blocks for the Cooked Sliced Chicken Breast 212 are placed in the conditioner. Assuming that there is only one person preparing this Component, the Sliced Avocado 116, Slice Tomatoes 202, Chopped Lettuce 204 are completed in series, then adding the Pepper 206, Salt 205 and Olive Oil 203 following the instructions per the Technique Building Block 208 and its corresponding Content 210. Once both Components are completed, they are added to the plate 802 to complete the preparation of the Chicken Salad Meal 410. The preparation time and orchestration sequence can vary not only by the skill of the user, by also other factors such as the number of people executing the conditioning protocol, the types of Components that make up the Meal, the availability and type of conditioner used.

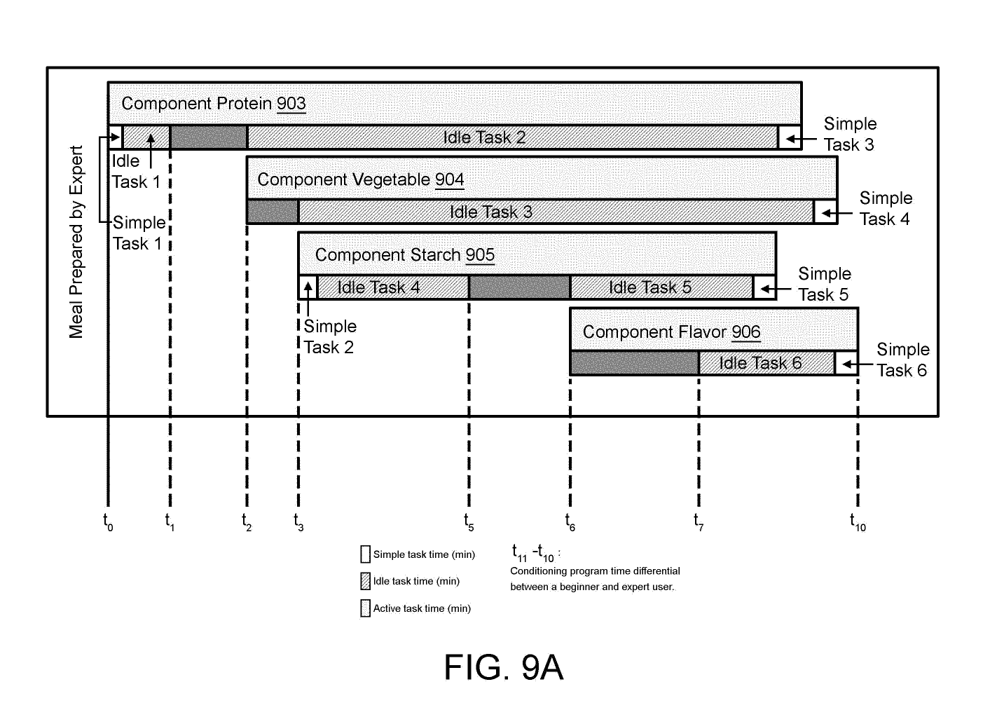

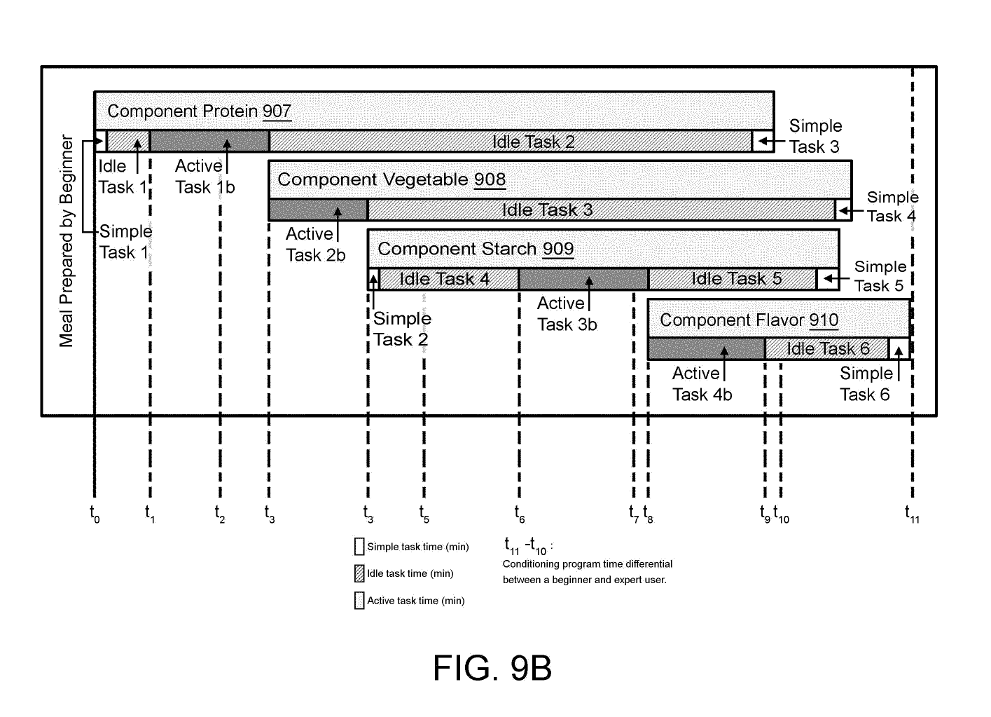

FIGS. 9A-9B illustrates in more detail the impact of the food preparer skill on the conditioning program as broken down into Components and more specifically its impact on idle, simple and active tasks. The Meal is comprised of 4 components: protein 903, 907; vegetable 904, 908; starch 905, 909; and flavor 906, 910. This figure shows how the skill level, in the form of a time block diagram, affects the time for execution of a dynamic and adaptive conditioning program as performed by an expert, 901. It is further compared with the time block diagram of the same dynamic and adaptive conditioning program as executed by a beginner in the culinary arts.

The orchestration of the Meal is done such that the execution of conditioning Components is completed within minutes of each other, similar to an end to end relationship of activities in Gantt chart. This is done such that the quality of the Components does not degrade or cool down if they sit for a long time waiting for the other Components to finish, especially is the Component is served hot or moist. Therefore, the start of execution for each Component can vary depending of the duration of the Component relative to other Components. The Component with the longest duration usually starts first, while the one with the shortest duration starts last. In this example, the Component protein starts first as it has the longest duration, while the Component Flavors starts last. The actual timing depends on the dependencies between the tasks and the constraint that no two active tasks can overlap if there is only one food preparer executing the dynamic and adaptive conditioning program.

Every Component is broken down into idle, simple, and active tasks. The simple and idle tasks have the same duration as they are independent of the skill of the food preparer. For instance, at the beginning of the execution of Component Protein (903, 907), the conditioning program starts with the simple task 1, which could be turning on the oven for preheating and placing a sheet pan inside the oven. It has the same duration in both time block diagrams, as it is independent of culinary skills.

Similarly, simple task 2 may comprise adding oil to a pan and placing the pan in the cooktop. It is followed by idle tasks 1, which has an identical duration in both Component Protein 903 and Component Protein 907. The idle task 1 may involve, for example, the use of a conditioner, such as an oven, that it is preheating. The oven preheats automatically, so that the food preparer is not involved. The same is true for idle tasks 3, 4, 5 & 7, they have the same duration as they are independent of the food preparer skills.

Idle tasks 3 may include cooking broccoli in an oven; idle task 4 may involve preheating the oil in a pan on a cooktop while idle task 5 may include cooking the ingredients or Dynamic Food Bolts in the preheated pan; and idle task 6 may involve the mixing ingredients and Food Bolts in a blender to make a salsa. However, idle tasks have dependencies on active tasks, which are dependent on the food preparer skills. Therefore, idle task 2 will start at t2 if the food preparer is an expert but will start at t3 if the food preparer is a beginner, given that is dependent on active task 1.

Examples of actions that the food preparer need to execute include cleaning and trussing a chicken or pork loin, which an experience chef can do it relatively fast, compared to one that needs to follow a video or other instruction in order to truss the protein. Therefore, active task 1e as executed by an expert has a shorter duration than active task 1b, executed by a beginner. Likewise, active task 2e is done faster than active task 2b, which may involve peeling, cutting and grating vegetables, or active task 3, which requires peeling, cutting, dicing or chopping potatoes or yams before they are pan fried, or active task 4, which requires peeling and chopping onions, chopping peppers, chilis and tomatoes, mincing garlic, and squeezing lemon for a salsa. All the active tasks require the involvement of the food preparer and thus their duration are skill dependent. Furthermore, parallel execution of the active tasks is not possible unless there is more than one food preparer. In the example, it is assumed that only one food preparer was executing the dynamic and adaptive conditioning program, thus, the active task 4 of the Component flavor cannot start until the active task 3 of the Component starch is completed.

In this example all Components end with a simple task, whether it is removing the chicken breast or pork chops (simple task 3) broccoli or potatoes (simple task 4) from the oven and turning the oven off, or removing the pan from the cooktop and placing its contents on a plate (simple task 5) or removing the freshly made salsa from the blender and setting it on a side dish (simple task 6).

Thus, in this example, the difference between the time between the conditioning program being executed by an expert (t10) vs that by a beginner (t11) is the difference of the sum of all active tasks executed by an expert (active tasks 1e-4e) and the sum of all active tasks executed by a beginner (active tasks 1b-4b).

As described above a novel method and system of decomposing conditioning programs based on a modular approach is provided. In some embodiments, a conditioning sequence is provided using (but not limited to) one or more of the following building block structures:

a. Ingredient Building Blocks

b. Content Building Block

c. Technique Building Block

d. Dynamic Food Bolts

e. Components

Of particular advantage, individual building blocks can be replaced, rather than the complete conditioning protocol, representing savings in time, money and effort.

In further embodiments a system and method for utilizing a computer based system to orchestration of a Meal is provided, based on the breakdown of the Meal Components to optimize preparation time based on one or more of:

Skill of the user

Type of appliance

Number of people involved in the preparation

Of particular advantage, the systems and methods of the present disclosure enable the state of the nutritional substance as a basis to determine in which building blocks it can be used. Filters for Meal Selections, based on user preferences (diet, allergies, intolerances) and conditioner available may be integrated.

### Exemplary Computer Functionality for Conditioning Protocols

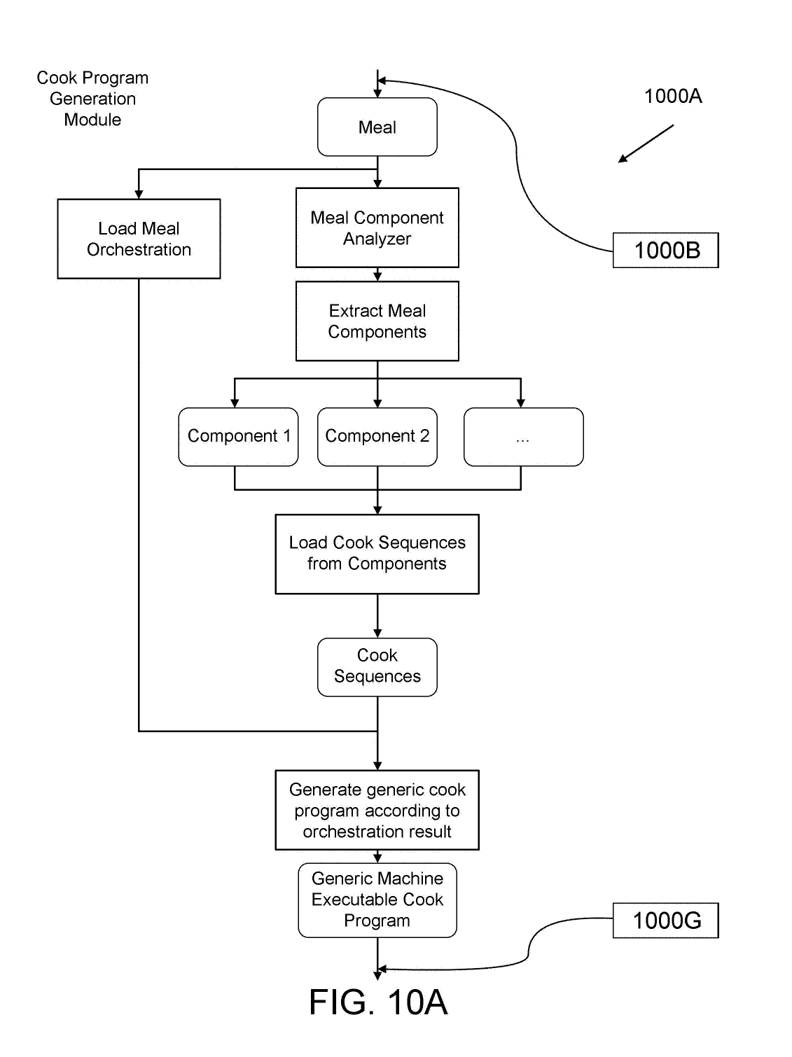

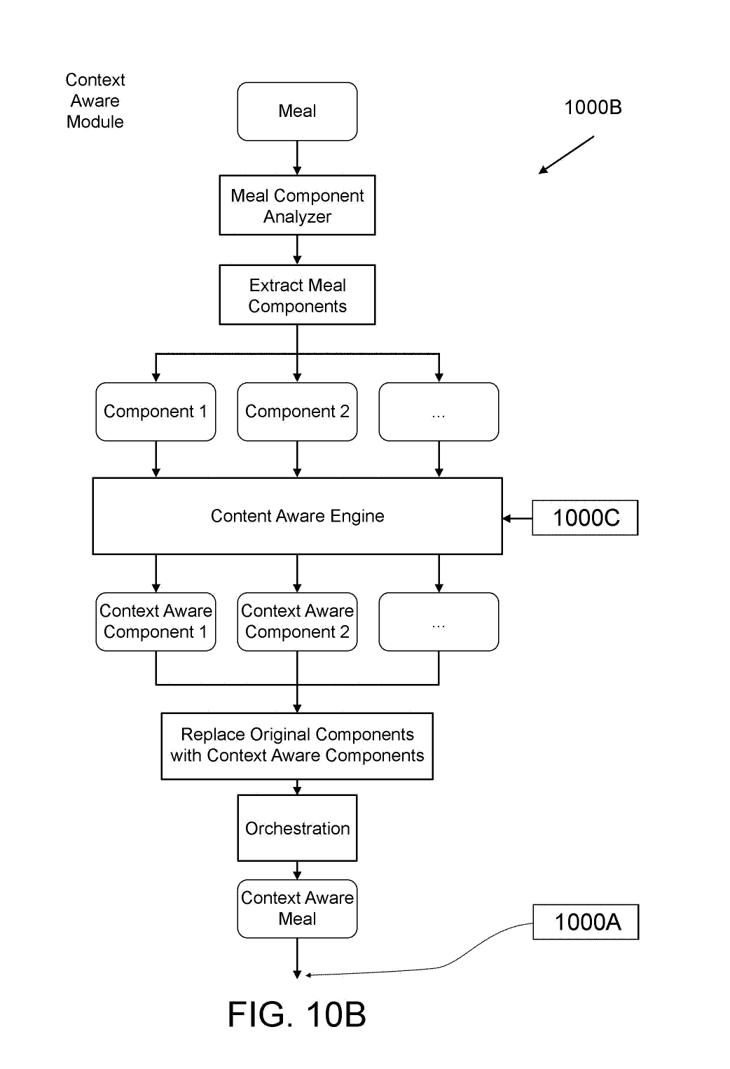

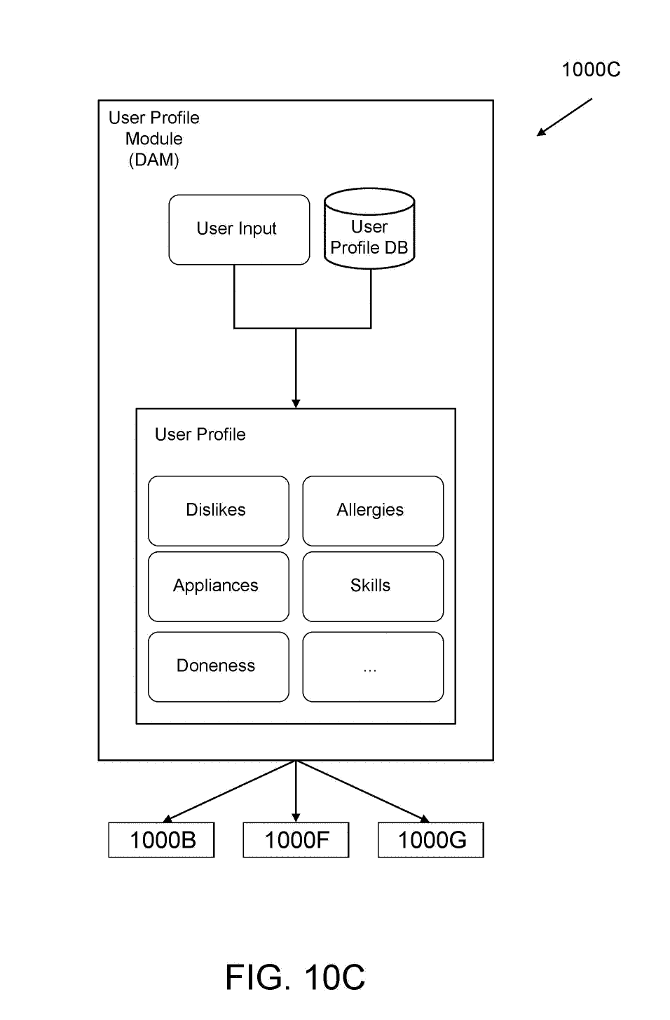

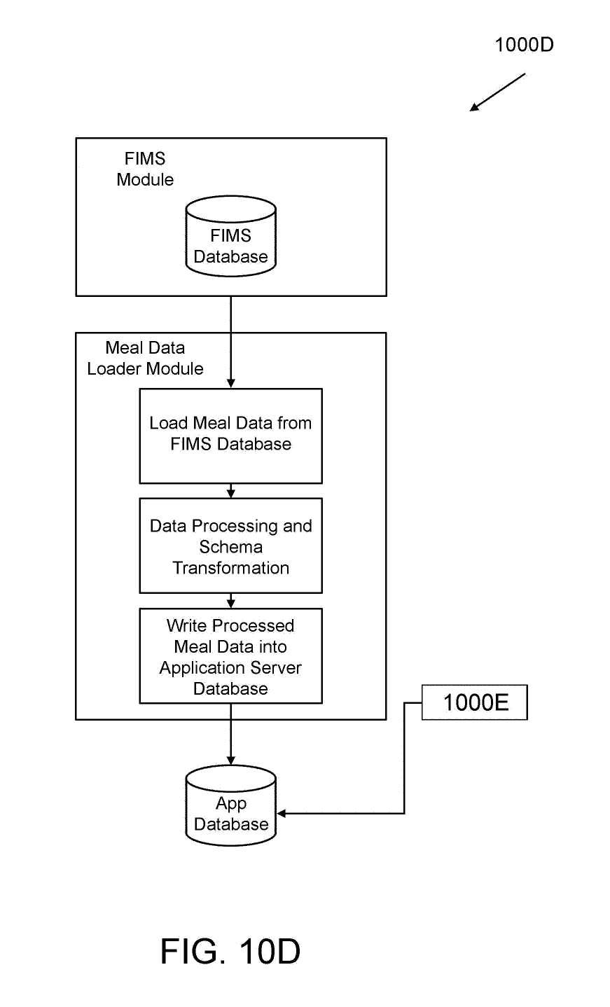

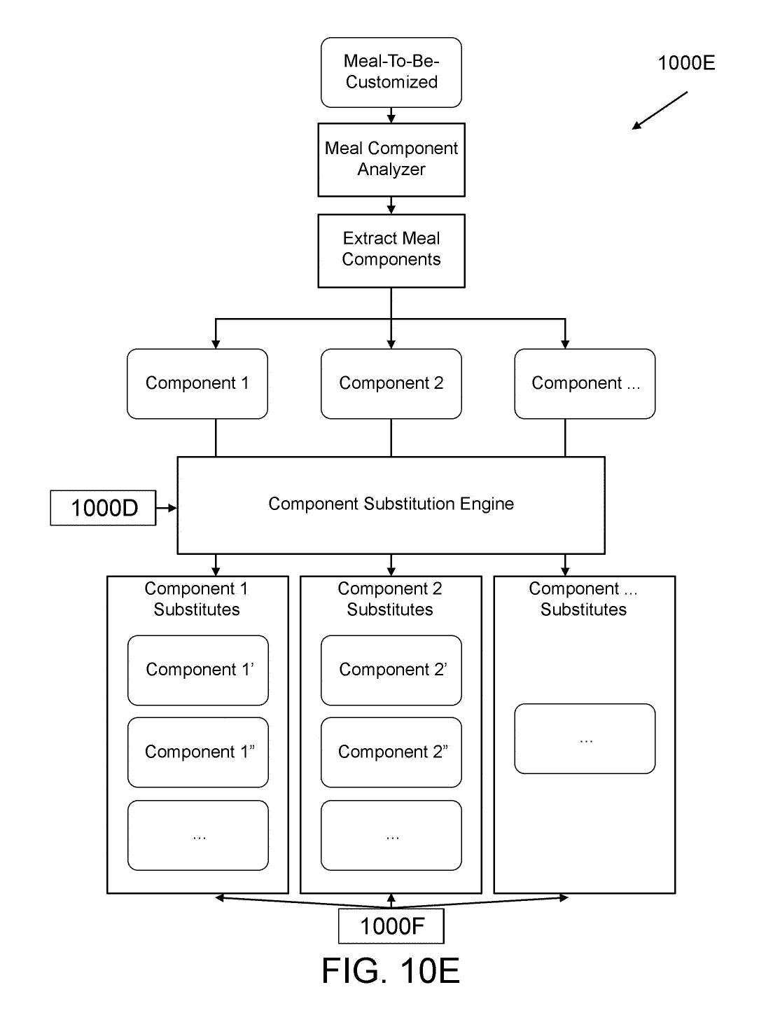

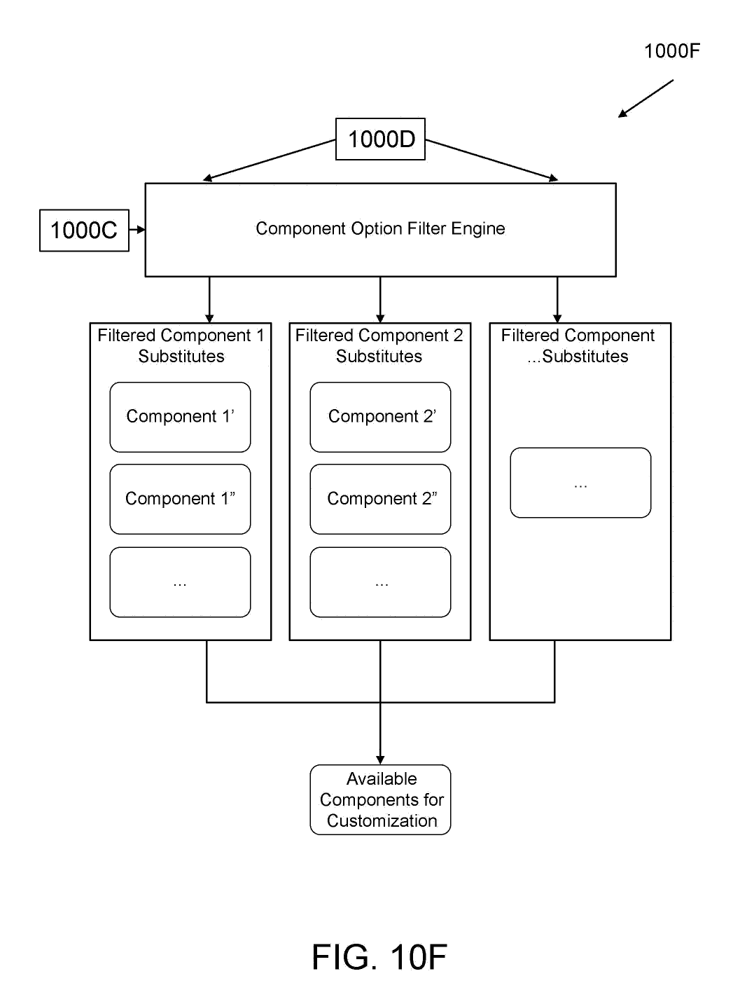

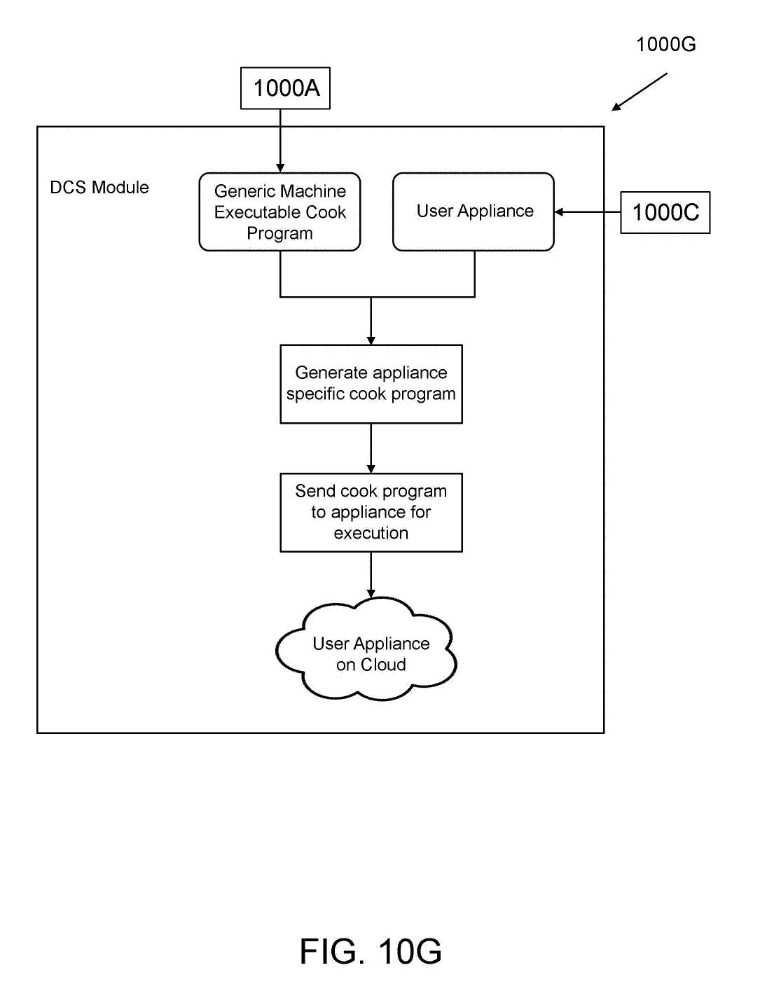

FIGS. 10A-10G show how various aspects of the present disclosure can be configured to communicate with each other, exchange information, and optimize the user's experience. The modules shown in FIGS. 10A-10G can be housed in a computing device or among multiple computing devices. The modules can further be provided for as one or more computer applications.

FIG. 10A shows an exemplary cook program generation module 1000A. Module 1000A can receive data from a context aware module 1000B (discussed later with respect to FIG. 10B). Based on the data received from module 1000B, module 1000A can provide for selecting a meal. In some examples, a user can select a meal at a user interface. Module 1000A can then provide for, in tandem, loading a meal orchestration and loading a meal component analyzer. The meal component analyzer can identify a set of components associated with the selected meal and extract each of the meal components into a list. Module 1000A can then provide for loading cook sequences associated with each of the extracted components. Each cook sequence can include a set of instructions. The instructions can be executable by a conditioner.

Module 1000A can then compile the list of cook sequences. Based on the meal loading orchestration results and the cook sequences, Module 1000A can generate a generic cooking program. The generic cooking program can include a cook timeline.

The cook timeline can have each of the cook sequences arranged with respect to each other so that each cook sequence is initiated at a certain point along the cook timeline. In some examples, arranging each of the cook sequences with respect to each other so that they are initiated at a certain point along the cook timeline further comprises determining a length of time in each of the cook sequences and arranging each of the cook sequences along the cook timeline so that the cook sequences all finish within a certain window of each other. In some examples, a length of the cook timeline is dependent on an expertise level associated with the user profile.

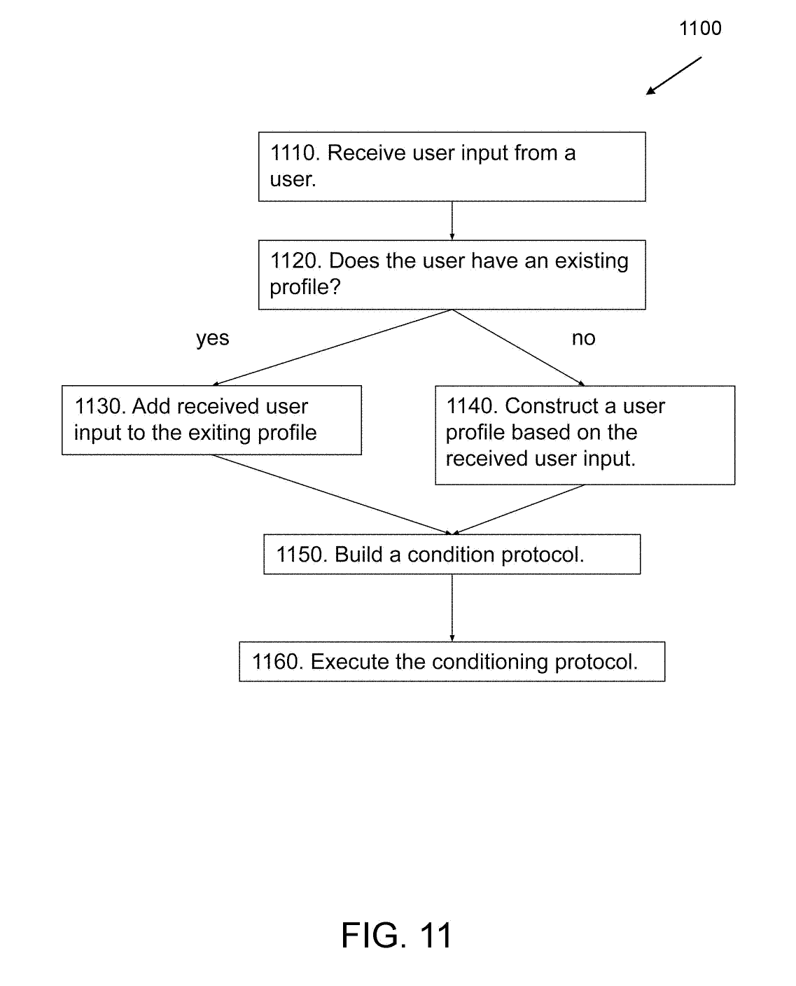

Module 1000A can then provide for executing the cook program (for example as discussed further with respect to step 1160 of FIG. 11). Module 1000A can additionally send the executed cook program to a conditioner as in 1000G (Discussed later with respect to FIG. 10G). In some examples, the generic cook program can be executed on a smart device. The smart device can have a display. The control system can initiate each of the set of cook sequences as the generic cook program advances along the cook timeline. The first set of instructions executable by a conditioner can be executed after the first of the loaded cook sequences is initiated.

In some examples, the first cook sequence can be associated with a first content and the first content can be displayed on the display after the first cook sequence is initiated. In some examples of the first embodiment, the first content comprises at least one of text, a video, or an image.

FIG. 10B shows an exemplary context aware module 1000B for altering a conditioning protocol based on user input and/or a user profile. A context aware module 1000B can provide for selecting a meal. Module 1000B can then provide for loading a meal component analyzer. The meal component analyzer can extract each of the meal components into a list and send the components through a context aware engine (discussed further with respect to module 1000C of FIG. 10C).

The context aware engine can produce context aware components and replace the original components with the new context aware components. For example, the context aware engine can substitute components according to user input (as provided for in step 1110 of FIG. 11). For example, the context aware engine can know to substitute components according to allergies or a user's dislike for a certain component. For example, if a user is allergic to gluten, each component with gluten can be referenced to a substitute non-gluten component in a database. After replacing the original components with the context aware components, module 1000B can provide for orchestrating a context aware meal. In some examples, the context aware meal can be sent back to module 1000A.

FIG. 10C shows an exemplary user profile module 1000C. For example, the user profile module can include user input and a user profile database. The user profile database can include one or more profiles of different users who may access the same conditioners and appliances. For example, there may be multiple user profiles within one household. A user profile can include user dislikes, likes, allergies, available appliances, skills, nutritional preferences, and doneness preferences for meat. The user profile module 1000C can be provided to modules 1000B, 1000F, and 1000G.

FIG. 10D shows an exemplary meal module 1000D. The exemplary meal module 1000D can include a meal database. A meal data loader module can receive meal data from the meal database. The meal data loader module can process the meal data and transform it into a user-friendly interface. The meal data loader module can write the processed meal data into an application server database. This database can be accessed by module 1000E (discussed further below).

FIGS. 10E-10F show an exemplary meal customization module 1000E and 1000F. The meal customization module can have a meal which needs to be customized. That meal can be sent to a meal component analyzer which extracts meal components into a list of components. The components can then go through a component substitution engine (as needed by module 1000D). The component substitution engine can provide a list of substitutes for each component. The list of substitutes can be sent to a component option filter engine and selected according to module 1000C. The component option filter engine can provide a list of filtered component substitutes and send that list as an available list of components for customization. For example, a user could view the list of customization components and make selections. These selections can be made, for example, during the process of building the conditioning protocol.

In one example of meal customization modules 1000E and 1000F, identifying a set of components associated with the meal can include a series of steps. First, the steps can provide for identifying a set of standard components associated with the meal. Second, the steps can provide for determining, based on a profile of the user stored in a second database, that at least one of the components should be substituted. Then, the steps can provide for identifying, in a database, a substitute component associated with the meal and associated with at least one of the components that should be substituted. Lastly, the steps can provide for outputting the set of components with the substitute component replacing the at least one of the components that should be substituted.

FIG. 10G shows an exemplary module 1000C for executing a conditioning protocol. Based on a built conditioning protocol, module 1000G can produce a generic machine executable cook program. Module 1000G can also retrieve information about a user appliance (or the user's conditioner). In some examples, this information can be selected by the user during the protocol building. Module 1000G can then provide for generating an appliance-specific cooking program. The module 1000G can send that cook program to the user appliance for execution (similar to step 1160 of FIG. 11 below). Module 1000G can connect with the user appliance via the Internet, Bluetooth, a wired connection, or other electronic means, as known to one skilled in the art.

### Methodology for Building a Conditioning Protocol

FIG. 11 shows an exemplary methodology 1100, according to an embodiment of the present disclosure. Methodology 1100 can begin at step 1110, by receiving user input from a user. The user input can include dietary preferences, dietary requirements, sensor data, available or preferred ingredients, available or preferred appliances, how many people will be preparing the food, and a meal selection. The present disclosure contemplates that the user input can comprise a wide range of information related to user preferences for food preparation.

In some examples, step 1110 can provide for receiving data from at least one sensor. The at least one sensor can be placed near enough to monitor an ingredient. For example, the sensor data can include a readiness of an ingredient. In some examples, the sensor can include at least one of a heat sensor, a camera, and a near infrared spectroscopy sensor.

The user input can be stored at a user interface. In some examples, the user interface be displayed on a tablet, mobile device, conditioner, computer, or other electronic device. The user can interact with the user interface via an application, for example. The user can enter user input directly before desiring a conditioning protocol, or in advance of requiring a conditioning protocol. In some examples, the user can create a user profile.

After receiving the user input in step 1110, methodology 1100 can provide for proceeding to step 1120 to determine whether the user has an existing user profile. A user profile can store any of the user input listed above with respect to step 1110, for example. Step 1120 can be performed at a storage unit.

If the user has an existing user profile, methodology 1100 proceeds to step 1130, where the storage unit can provide for adding the received user input to the existing profile.

If the user does not have an existing user profile, methodology 1100 proceeds to step 1140, where the storage unit can provide for creating a user profile based on the user's entered input.

After completing step 1130 or step 1140, methodology 1100 can proceed to step 1150 to build a conditioning protocol. The conditioning protocol can be based on the user profile, the user input, and a stored set of exemplary protocols. The stored set of exemplary protocols can be stored on the storage unit, for example.

In some examples of step 1150, the conditioning protocol can include (1) selecting a protocol of the stored set of exemplary protocols and (2) automatically adjusting at least one element of said protocol based on at least one of the user input and the existing profile. In some examples of the first embodiment, the at least one element can include at least one of: an ingredient, an order of protocol elements, a length of time of a protocol element, a length of time of the built conditioning protocol, a technique step, and an appliance step.

In some examples of the step 1150, the adjusting can include replacing, removing, or adding a new element to said protocol.

In some examples of step 1150, the built conditioning protocol can include at least one of: an ingredient building block, a content building block, a dynamic food bolt, a component, and an appliance building block.

After building the conditioning protocol at step 1150, the present disclosure can provide for executing the built conditioning protocol in a conditioner at step 1160. For example, step 1160 can provide for automatically initiating a cooking process on the conditioner.

In some examples of methodology 1100, the method can further provide for displaying the built conditioning protocol at the user interface. The built conditioning protocol can include at least one of verbal user instructions, textual user instructions, and digital media instructions. For example, the conditioning protocol can simultaneously provide video instructions and textual instructions to a user, while providing automated electronic instructions to the conditioner.

In some examples of methodology 1100, the user interface, the storage unit, and the conditioner can be a single component. In other examples, one or more of the three can be separate components.

### Computer & Hardware Implementation of Disclosure

It should initially be understood that the disclosure herein may be implemented with any type of hardware and/or software, and may be a pre-programmed general purpose computing device. For example, the system may be implemented using a server, a personal computer, a portable computer, a thin client, or any suitable device or devices. The disclosure and/or components thereof may be a single device at a single location, or multiple devices at a single, or multiple, locations that are connected together using any appropriate communication protocols over any communication medium such as electric cable, fiber optic cable, or in a wireless manner.

It should also be noted that the disclosure is illustrated and discussed herein as having a plurality of modules which perform particular functions. It should be understood that these modules are merely schematically illustrated based on their function for clarity purposes only, and do not necessary represent specific hardware or software. In this regard, these modules may be hardware and/or software implemented to substantially perform the particular functions discussed. Moreover, the modules may be combined together within the disclosure, or divided into additional modules based on the particular function desired. Thus, the disclosure should not be construed to limit the present invention, but merely be understood to illustrate one example implementation thereof.

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a “data processing apparatus” on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

### CONCLUSION

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

What is claimed is:

1. A method for creating an interactive and executable cooking program, the method comprising:
receiving, at a user interface, a selection of a meal;
identifying, by a control system, a set of components associated with the meal;
loading, from a database, cook sequences associated with each of the set of components, wherein a first cook sequence associated with a first component of the set of components comprises a first set of instructions executable by a conditioner;
generating, by the control system, a generic cook program based on the cook sequences comprising a cook timeline by arranging each of the cook sequences with respect to each other so that they are initiated at a certain point along the cook timeline; and
executing, by the control system, the generic cook program on a smart device comprising a display, and initiating each of the set of cook sequences as the generic cook program advances along the cook timeline, and wherein the first set of instructions executable by a conditioner is executed after the first of the loaded cook sequences is initiated.

2. The method of claim 1, wherein the first cook sequence is associated with a first content and wherein the first content is displayed on the display after the first cook sequence is initiated.

3. The method of claim 1, wherein identifying a set of components associated with the meal further comprises:
identifying a set of standard components associated with the meal;
determining, based on a profile of the user stored in a second database, that at least one of the components should be substituted;
identifying, in a database, a substitute component associated with the meal and associated with the at least one of the components that should be substituted; and
outputting the set of components with the substitute component replacing the at least one of the components that should be substituted.

4. The method of claim 3, wherein the profile of the user comprises at least one of allergy information, nutritional preferences, or cooking preferences.

5. The method of claim 1, wherein arranging each of the cook sequences with respect to each other so that they are initiated at a certain point along the cook timeline, further comprises determining the length in time of each of the cook sequences and arranging them along the cook timeline so that they all finish within a certain time window of each other.

6. The method of claim 1, wherein the length of the cook timeline is dependent on an expertise level associated with the user profile.

7. The method of claim 1, wherein the first content comprises one of: text, a video, or an image.

8. A method for creating a conditioning protocol for a conditioner, comprising:
receiving, at a user interface, user input from a user;
determining, at a remote database, whether the user has an existing profile;
based on determining that the user has an existing profile, adding the received user input to the existing profile;
based on determining that the user does not have an existing profile, constructing a profile for the user, based on the user input, to yield an existing profile;
building a conditioning protocol, wherein the conditioning protocol is based on the existing profile, the user input, and a stored set of exemplary protocols; and
executing the built conditioning protocol in a conditioner.

9. The method of claim 8, wherein the method further comprises displaying the built conditioning protocol at the user interface.

10. The method of claim 8, wherein the user input comprises any of: at least one dietary preference, at least one dietary requirement, sensor data, at least one available ingredient, at least one available appliance, a number of food preparers, and a meal selection.

11. The method of claim 10, wherein the sensor data comprises a readiness of an ingredient.

12. The method of claim 10, wherein the sensor data can be collected by at least one sensor configured to receive data from the at least one ingredient.

13. The method of claim 12, wherein the at least one sensor comprises at least one of a heat sensor, a camera, and a near infrared spectroscopy sensor.

14. The method of claim 8, wherein building the conditioning protocol further comprises:
selecting a protocol of the stored set of exemplary protocols;
automatically adjusting at least one element of said protocol based on at least one of the user input and the existing profile.

15. The method of claim 14, wherein the at least one element comprises any of: an ingredient, an order of protocol elements, a length of time of a protocol element, a length of time of the built conditioning protocol, a technique step, and an appliance step.

16. The method of claim 14, wherein the adjusting can comprise replacing, removing, or adding a new element to said protocol.

17. The method of claim 8, wherein the built conditioning protocol comprises any of: an ingredient building block, a content building block, a dynamic food bolt, a component, and an appliance building block.

18. The method of claim 8, wherein the built conditioning protocol comprises at least one of verbal user instructions, textual user instructions, and digital media instructions.

19. A non-transitory computer-readable medium having stored thereon a computer program executable by a computing device, the computer program comprising code sections for causing the computing device to:
receive, at a user interface, user input from a user;
determine, at a remote database, whether the user has an existing profile;
based on determining that the user has an existing profile, add the received user input to the existing profile;
based on determining that the user does not have an existing profile, construct a profile for the user based on the received user input to yield an existing profile;
build a conditioning protocol, wherein the conditioning protocol is based on the existing profile, the user input, and a stored set of exemplary protocols; and
execute the built conditioning protocol in a conditioner.
